(19) United States
(12) Patent Application Publication
(10) Pub. No.: US 2002/0069154 A1
(43) Pub. Date: Jun. 6, 2002

(54) Network system for handling requests for proposal relating to the provision of legal services

(76) Inventor: Scott J. Fields, Blue Bell, PA (US)

Correspondence Address: OBERMAYER REBMANN MAXWELL & HIPPEL LLP, 1617 JOHN F KENNEDY BLVD, 19TH FLOOR, PHILIDELPHIA, PA, 19103, US

(21) Appl. No.: 09/851,533

(22) Filed: May 8, 2001

Related U.S. Application Data
(63) Continuation-in-part of application No. 09/710,779, filed on Nov. 9, 2000.
(60) Provisional application No. 60/164,494, filed on Nov. 9, 1999.

(51) Int. Cl. G06F 17/60

(52) U.S. Cl. 705/37

(57) ABSTRACT

An apparatus for managing communications between a patent attorney and prospective client comprising: a control unit for receiving a client request generated by a prospective client, relating to a desire for legal services including a fee request; means for assisting a client in formulating a request for proposal to be distributed to a patent attorney throughout the system; means for distributing the request for proposal to said attorneys; and means for receiving bids from attorneys who receive the request for proposal.

### CLAIM OF PRIORITY

This application is a continuation-in-part of U.S. Ser. No. 09/710,779 filed Nov. 9, 2000, which derives priority from co-pending Provisional Application No. 60/164,494, filed Nov. 9, 1999. Both applications are incorporated herein by reference.

### FIELD OF THE INVENTION

The present invention is directed to online computer systems. In particular, the present invention is specifically directed to online computer systems which can be used to post requests for proposal relating to the provision of legal services in general, and intellectual property legal services, in particular.

### BACKGROUND OF THE INVENTION

The Internet or World Wide Web is one of the most critical technological developments of the 1990's. The Internet has provided vast economic opportunities for numerous businesses and industries to vastly expand the number and quality of their services. One of the earliest and fastest emerging areas of Internet activity has been in providing rapid, up-to-the-minute business information. To date, a number of patents have issued on Internet related systems that cover a wide array of business information and electronic commerce (e-commerce) applications.

Heretofore, the Internet has been applied to the on-line auctioning of experts. U.S. Pat. No. 5,862,223 to Walker discloses an expert matching method and apparatus. This system matches communications between an expert having particular qualifications and an end user seeking a solution to an expert request. In a preferred embodiment, the apparatus includes a controller having a database for storing expert qualifications. In one embodiment, the controller receives an expert request. A search program identifies experts qualified to respond to the expert request. The expert request is then transmitted to the expert which results in an expert answer transmitted to and received by the central controller. After authentication of the expert answer, using a wide range of security levels from passwords to cryptography, the answer is forwarded to the end user.

U.S. Pat. No. 5,835,896 discloses a system and method for conducting a multi-person interactive ad auction in a variety of formats without using a human auctioneer to conduct the auction. This system is preferably implemented in software and allows a group of bidders to interactively place bids over a computer and communications network. Those bids are recorded by the system and bidders are updated with current auction status information.

When appropriate, the system closes the auction from further bidding and notifies the winning bidders and losers as to the auction outcome. Electronic auctions held over the Internet using electronic mail (e-mail) have also gained wide popularity. A recent innovation applied to e-mail auctions is the use of the Internet to post descriptions of the merchandise and to show the current high bids. Security brokerage firms for years have used automated transaction systems for matching buy and sell orders for securities. For example, the New York Stock Exchange's DOTS (Direct Order Transmission System) and NASDAQ SOES (Small Order Execution System) systems offer complete electronic matching of buyers and sellers.

A number of U.S. patents have issued related to various forms of electronic commerce. These patents fall into three broad categories: (1) patents relating to on-line networks; (2) patents relating to electronic commerce over on-line networks; and (3) patents relating to various forms of securities trading via electronic means. U.S. Pat. No. 5,406,475 entitled “Data Processing Network Having a Plurality of Independent Subscribers”, U.S. Pat. No. 5,235,680 entitled “Apparatus and Method for Communicating Textural and Image Information between a Host Computer and a Remote Display Terminal”, and U.S. Pat. No. 5,310,997 entitled “Automated Order and Delivery System” are representative of the prior art.

A second group of patents relating to electronic commerce, U.S. Pat. No. 5,285,383 entitled “Method for Carrying Out Transactions Using Electronic Title” and U.S. Pat. No. 5,297,031 entitled “Method and Apparatus for Order Management and Market Brokers,” describe various means for conducting transactions over electronic communications networks. U.S. Pat. No. 4,789,928 discloses a means for soliciting bids over an electronic network from bidders who are remote to the site of a live auction.

The third group of patents relates to electronic commerce in the field of securities trading. U.S. Pat. No. 4,412,287 entitled “Automatic Stock Exchange”, for example, discloses means for prospective buyers to post offers to buy a given security at a specific price and for prospective sellers to post offers to sell a given security at a specific price.

To date, there has not been a system which matches intellectual property attorneys with prospective clients or one in which attorneys may respond to a request for proposal from prospective clients. Many large multinational organizations procure their legal services by putting out requests for proposal and soliciting bids from interested attorneys. Like an auction, such a system would facilitate competition.

While there have been a number of electronic Internet auction systems, none have been applied to the legal profession and, in particular, the area of intellectual property law. Most importantly, none generate realistic and competitive fee quotes and bids based upon real life inputs provided by the client.

Such a system would be desirable because the practice of intellectual property law is a national and international practice in which fees and levels of expertise vary widely throughout the United States. Unlike other attorneys, registered patent attorneys are members of a national bar who can represent individuals residing in diverse geographic locations. There is a demand for such a system because clients desire cost effective legal services and attorneys desire systems that reduce the acquisition costs of new legal clients.

The 1997 and 1999 Reports of the Economic Survey of the American Intellectual Property Law Association establish that the fees charged by intellectual property attorneys vary greatly across different geographic areas. For example, a patent application drafted in New York can cost as much as $5,000.00 more than a similar application filed by a practitioner in Atlanta, Ga., even though both attorneys have similar levels of technical experience.

Further, the rise in use of e-mail, facsimile transmission and video conferencing has further minimized the need for attorneys and clients to interact face to face. Frequently, patent attorneys and agents file patents and trademarks for clients whom they have never seen or met in person. This is particularly true in the area of international filings. Because of the worldwide nature of intellectual property law, it is possible to provide a nationwide system by which clients can post requests for proposal from potential intellectual property law clients, which can then be responded to by intellectual property attorneys and agents.

A further constraint on the application of an on-line auction, RFP or bidding system for attorneys is the ethical prohibitions faced by intellectual property and other attorneys against direct solicitation and the like. Any solution for matching intellectual property clients and attorneys must be done so in a manner which does not run afoul of the serious ethical constraints imposed upon intellectual property lawyers and agents.

To date, there have been several systems on the market which generate legal related RFP's. Two commercial products currently on the market include Mondus and eLance. Both systems have shortcomings in the IP field because they do not generate realistic fee estimates. Most unknowledgeable clients do not have any clear understanding as to what an appropriate legal fee comprises, particularly for intellectual property. Accordingly, clients place unrealistic numbers when they use these sites. Such systems are largely useless or viewed as an annoyance by attorneys for this reason.

It is therefore an object of the present invention to provide a system, accessible via a computer network, for providing means for clients to access intellectual property law attorneys and agents.

It is another object of the present invention to provide a networked computer system whereby information regarding legal RFPs (Requests For Proposal) and associated responses can be instantaneously accessed regarding legal matters, including but not limited to intellectual property legal matters.

It is a further object of the present invention to provide a system in which users and subscribers access the system via the Internet or World Wide Web and can be provided with a user interface which assists them in formulating bids and RFPs and which generates realistic legal fee quotes.

It is still a further object of the present invention to provide a system by which intellectual property practitioners may respond to requests for proposal in a manner consistent with ethical rules and canons governing the practice of intellectual property law attorneys.

It is a further object of the present invention to provide a system by which groups of RFPs can be put together to provide group billing and discounts and by which legal services can be compiled and contracted out in a group.

It is a further object of the present invention to provide a system in which government foreign fees can be calculated and in which RFPs attorneys can further be grouped for clients to be bid en masse.

It is still a further object of the present invention to provide a system which can be use for establishing fees for equity based transactions and for establish values for use in barter.

It is still a further object of the present invention to provide system that can be used to generate legal fee quotes independent of an RFP system.

These and other objects of the present invention will become apparent from the detailed description and from the following summary, detailed description and claims.

### SUMMARY OF THE INVENTION

In one embodiment, the present invention comprises an apparatus for managing communications between an intellectual property attorney and prospective client comprising a control unit for receiving a request generated by a prospective client, relating to a desire for legal services from an intellectual property attorney, means for assisting a client in formulating a request for proposal to be distributed to intellectual property attorneys throughout the system including the generation of a customized fee quote based upon client inputs, means for distributing the request for proposal to said attorneys, and means for receiving responses from attorneys who receive the request for proposal.

In yet another embodiment, the present invention comprises an intellectual property attorney matching apparatus for managing communications between an intellectual property attorney and a prospective client seeking the services of said attorney. In particular, the invention comprises a control unit for receiving a request from a prospective client relating to desired intellectual property law services, means for assisting the prospective client in formulating a request for proposal including a fee quote to be formatted and distributed throughout a network, means for distributing the request for proposal throughout a network and means for intellectual property attorneys to respond to the request for proposal with a bid.

A further embodiment of the present invention, a method for electronically managing communications between an intellectual property attorney having particular qualifications and a potential client seeking a solution to a legal problem, comprising the steps of providing a control unit having a database for storing therein a plurality of intellectual property practitioners, providing an interface to an end user to the system to formulate a request for proposal in conjunction with a request for legal services including a fee quote generated by the system based upon a plurality of inputs, sending out the request for proposal to a plurality of intellectual property practitioners who may respond to the request for proposal.

In still a further embodiment, the present invention is directed to a system for generating fee quotes based upon a series of client inputs. These and other objects of the present invention will become apparent from the detailed description which follows.

### BRIEF DESCRIPTION OF THE FIGURES

FIG. 1 is a block diagram of the request for proposal generation system of the present invention.

FIG. 2 is still a distributed embodiment of the request for proposal generation system of the present invention.

FIG. 3 is an overall site map in accordance with the present invention.

FIGS. 4-7A illustrate a series of input screens for use by clients in conjunction with a legal request for proposal generation system in accordance with the present invention.

FIGS. 7B-10 illustrate an attorney front end interface for the present invention.

FIGS. 11 to 19 illustrate the user interface for formatting a patent based RFP.

FIGS. 20 to 21 illustrate a front end for generating a trademark/service mark based RFP.

FIGS. 22 to 24 illustrate the system for generating a copyright RFP.

FIGS. 25 to 27 illustrate a litigation RFP generation system.

FIGS. 28 to 29A illustrate the creation of a miscellaneous RFP.

FIGS. 30A to 30E illustrate the database table required to formulate the patent based FRFPs

FIG. 31 illustrates a fee table for patent search and prosecution.

FIG. 32 illustrates a fee table for copyright registration

FIG. 33 illustrates the fee table for trademark clearance, registration and prosecution.

FIG. 34 illustrates a geographic breakdown chart in accordance with the present invention.

FIG. 35 illustrates a flow diagram of the operation of the present invention.

FIGS. 36A and 36B illustrates a front end for a simple fee quote generation system in accordance with the present invention.

### DETAILED DESCRIPTION OF THE PREFERRED EMBODIMENT

The present invention is directed to a system for placing requests for proposal for attorneys and patent agents over communication networks using, for example, personal computers. In further embodiments, the present invention is directed to a system for generating legal fees for intellectual property legal work, including legal fees, and for generating government fees and fees for foreign or international intellectual property legal work. In yet a further embodiment, the invention is specifically directed to a system for grouping legal fees to be bid out in a group. The present invention can, in one sub-embodiment comprise a system generating a fee quote or estimate in the absence of an RFP system.

It is to be appreciated that while the present invention is being described in the context of a site and system for joining IP lawyer and potential clients, it is to be appreciated that the teachings of the present invention, and most particularly, the generation of legal fees based upon real client inputs are applicable to other legal and non-legal applications.

While the present invention is being described in the context of a system using a personal computer, the manner of the end user device is not critical to the present invention. The present invention may be used with any system that connects to the Internet or uses other IP transport methods. The end user device can comprise any end user device which can connect to a network such as a wireless device, palm pilot, PDA, end user work station or hand-held device.

In a most preferred embodiment, the present invention is directed to a system for placing requests for proposal and bids relating to intellectual property attorneys and agents, and the provision of intellectual property law services. It is to be appreciated that the teachings of the present invention are equally applicable to other areas of the legal profession as well. In short, the teachings of the present invention are applicable to any application in which specific fee estimates must be put forth based upon a set of variables. This includes all areas of the legal profession, accounting profession, IT profession, etc.

Over the past fifteen (15) years, personal computers have become relatively powerful and inexpensive and have gained widespread use in a significant number of homes and businesses. With a modem, personal computers can communicate with other computers through communication networks and access many resources on the so-called “Information Super Highway.” Companies such as America Online, CompuServe, and Prodigy, which traditionally provided so-called “content” over proprietary networks, have begun to provide access by personal computer users to an expansive international network of computer networks known as the Internet.

As is well known by those skilled in the art, the World Wide Web is a graphical sub-network of the Internet. With common “Web Browser” software such as Mosaic, Netscape Navigator, or Microsoft Explorer, end users may easily access Internet information and services on the World Wide Web. A web browser handles the functions of locating and targeting information on the Internet and displaying the information provided by the Web Server. The World Wide Web utilizes technology called “Hyper-Text” to organize, search and present information on the Internet. Using a web browser, the end user can select a word (“Hyper-Text word”) from a view document and be linked to another document featuring information related to the word.

The present invention is broadly directed to a computer network for distributing information regarding requests for proposal from prospective clients and responses from attorneys in general, and patent or intellectual property attorneys and agents in particular. The present invention is designed, in one embodiment, to be utilized on the World Wide Web or Internet, although the present invention is equally applicable to other network environments. As noted above, the present invention is similarly related to user interfaces which are not computers such as palm pilots, wireless and cellular devices.

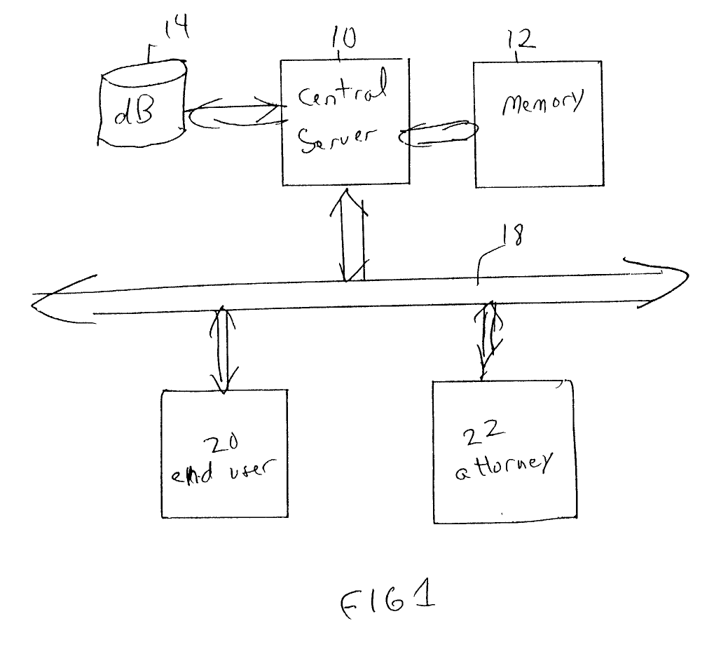

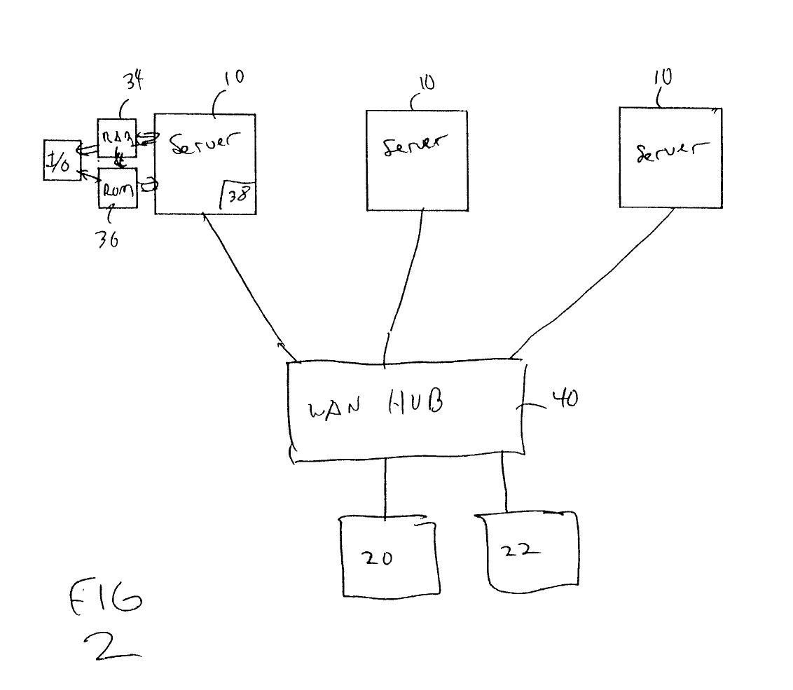

Referring now to FIG. 1, the present invention is directed to a system for placing requests for proposal to be responded to by intellectual property attorneys and agents who desire to participate in the system. As will be discussed in detail below, the present invention can be utilized to provide information regarding legal fees and to provide and generate RFPs for any application in which a fee quote is required, including other areas of the legal profession and other services for which fee quotes may be applicable.

The individual IP attorneys can then respond to requests for proposal from individual client inquiries. The present invention is directed to a system by which prospective clients can contact and request the services of attorneys based upon price, level of expertise and other desired professional and experience criteria. A critical feature of the present invention is the provision of a novel system that generates realistic legal fee quotes based upon a series of client inputs.

As shown in FIG. 1, the present invention, in a simplest embodiment, comprises a network system including a central computer server 10 with memory 12 and database 14. The central computer server 10 may run on an operating system such as the Windows NT based operating system or, alternatively, a more powerful system such as the Solaris operating system by Sun Microsystems. It is to be noted that the nature of the operating system for use with the present invention is not critical to the operation of the present invention. The database 14 stores an application program which carries out the objectives of the present invention.

Database 14 is preferably a database such as SQL database or, alternatively, the Oracle 7 or 8 database system, developed and manufactured by Oracle Corporation. The system is linked via a global computer network 18 to individual end users 20 or clients who desire to place requests for proposal to attorneys 22 who desire to respond to the requests for proposal. For the purposes of this application, the term attorney also refers to and includes registered patent agents. It is to be emphasized that while the present invention is being described in the context of Intellectual Property legal services, its teachings are applicable to a wide range of legal services.

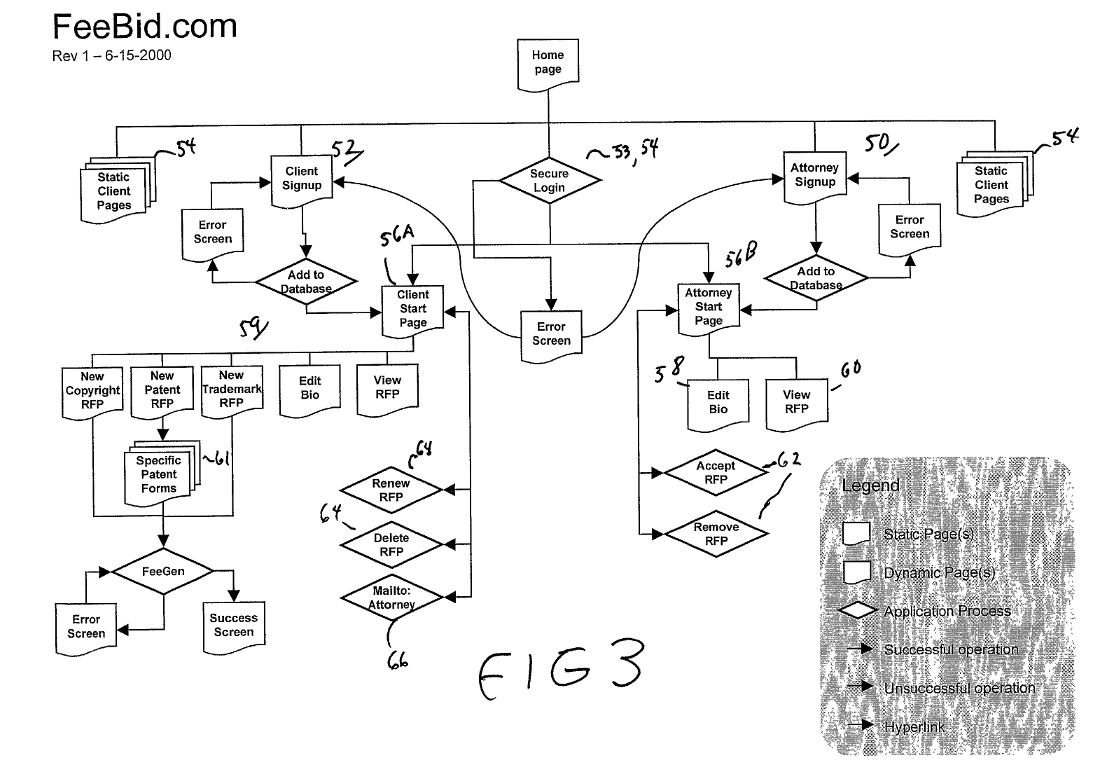

While the above embodiment describes a single computer acting as a central processor, those skilled in the art will realize that the functionality can be distributed over a plurality of computers. Thus, in another embodiment, central computer 10 may be configured as a distributed architecture system, as shown in FIG. 2, wherein the databases and processors are housed in separate units or locations.

As shown in FIG. 2, in a distributed computer system, the central computer system 10 performs primary processing functions and contains at a minimum RAM 34, ROM 36 and a general processor 38. Each of these controllers is attached to WAN hub 40 which serves as the primary communication link with the other devices. WAN hub 40 may have minimal processing capability itself, serving primarily as a communications router. Although only three controllers are shown in the embodiment, those skilled in the art will appreciate that an almost unlimited number of controllers may be supported. In such a configuration, each controller is in communication with its constituent parts, but the processor and/or data storage functions are performed by stand alone units.

In a preferred embodiment, the central processor 10 hosts a web site and application comprising a plurality of user screens and back-end database applications which are accessed via a web browser residing on the systems of the end user 20 and the intellectual property attorney 22. The user screens access a backend database comprising the invention in one embodiment. The Figures illustrate a so-called front end of the system and are shown in the context of a commercial website under the commercial name and URL (universal resource locator) Feebid.com.

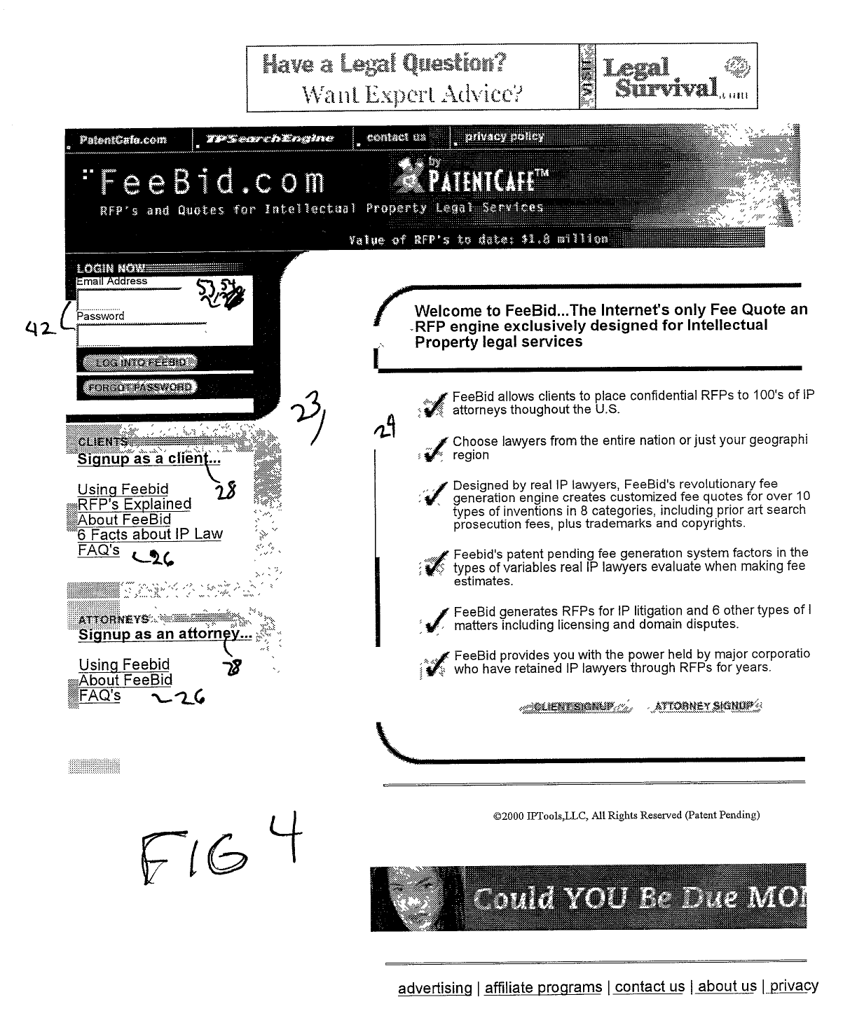

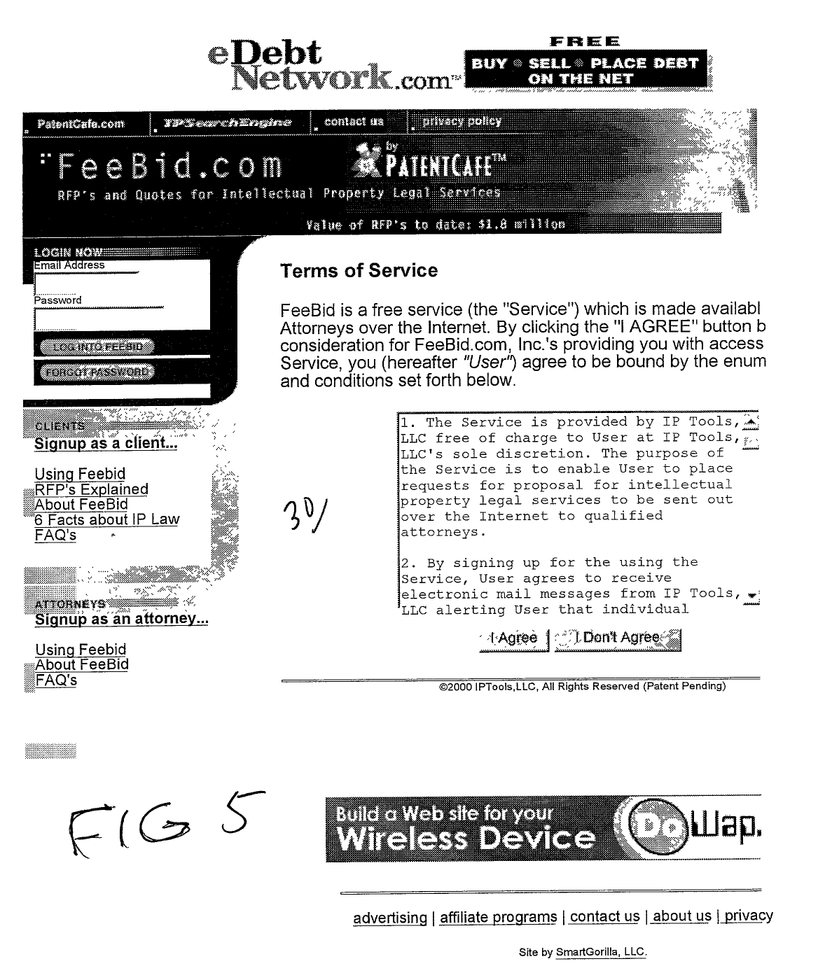

As shown in FIG. 3, a preferred site map of the present invention is shown. The application of the present invention comprises a dual entry application having both attorney sign-up 50 and client sign-up areas 52. Both the client and attorney areas 50, 52 present the respective entities with static information pages such as promotional and explanatory material regarding the site and technology 54. The site includes both a client log-in 53 and an attorney log-in area 54. Both log-in areas lead to respective client and attorney start pages 56A, 56B.

The start pages 56A, 56B, to be discussed in greater detail below, will comprise private areas of the site in which the member attorneys and clients can locate pending RFP's and monitor their individual traffic. As shown, the site further includes areas where attorneys can edit their biographies 58, view existing RFP's 60 and accept/remove existing RFP's 62. The client Start Page 56A permits the client to renew and delete RFPs 64 and to send mail to a member attorneys who have responded to an RFP 66.

The client Start Page 56A further enables the client to post new RFP's, namely patent, trademark, copyright, miscellaneous and litigation 59. As will be discussed below, the patent forms will take the client through one of seven categories of invention 61 and elicit detailed information from which a unique custom fee quote can be generated.

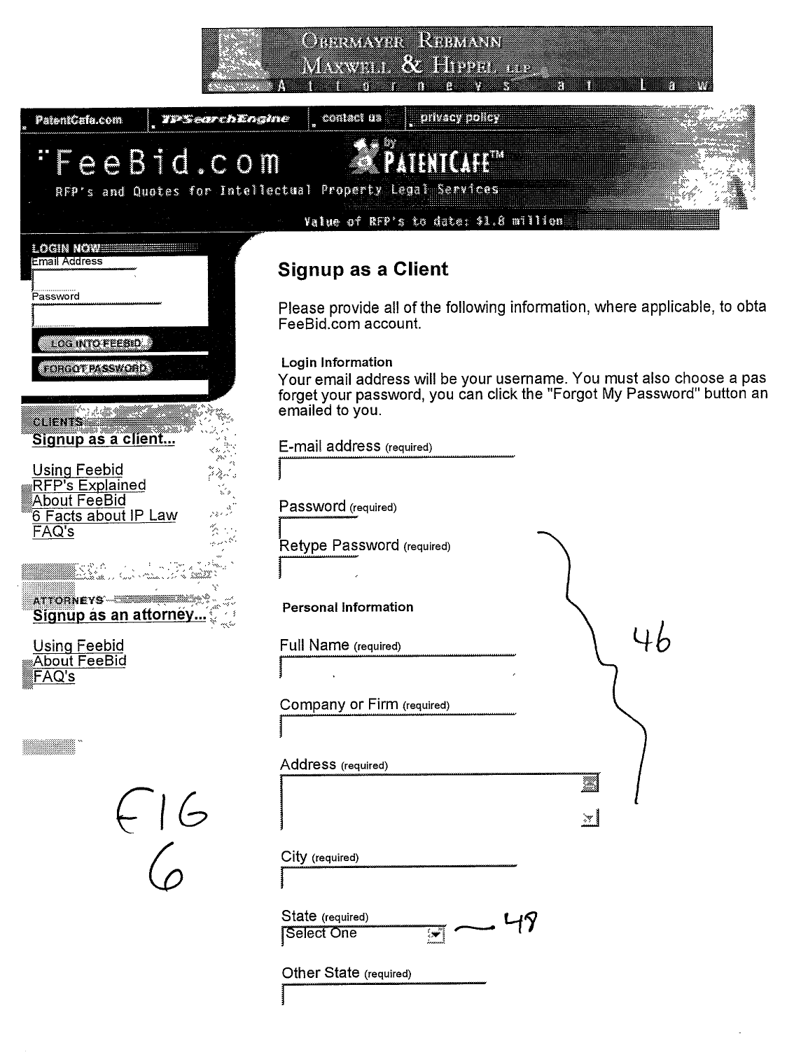

Referring to FIGS. 4-7A, the client front end of the system is shown in detail. As shown in FIG. 4, a user screen 23 which is accessible via the web browser of the client at the URL WWW.FEEBID.COM comprises an introductory text 24 which will introduce the service to the end user (both client and attorney). This page will preferably include FAQ (Frequently Asked Questions) 26 and areas for both clients and attorneys to sign up 28. Member attorneys and clients can log in 53, 54.

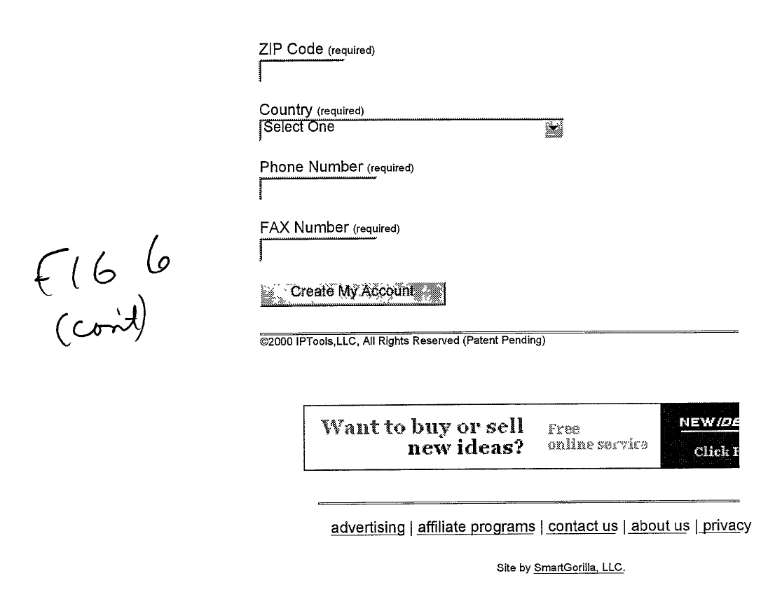

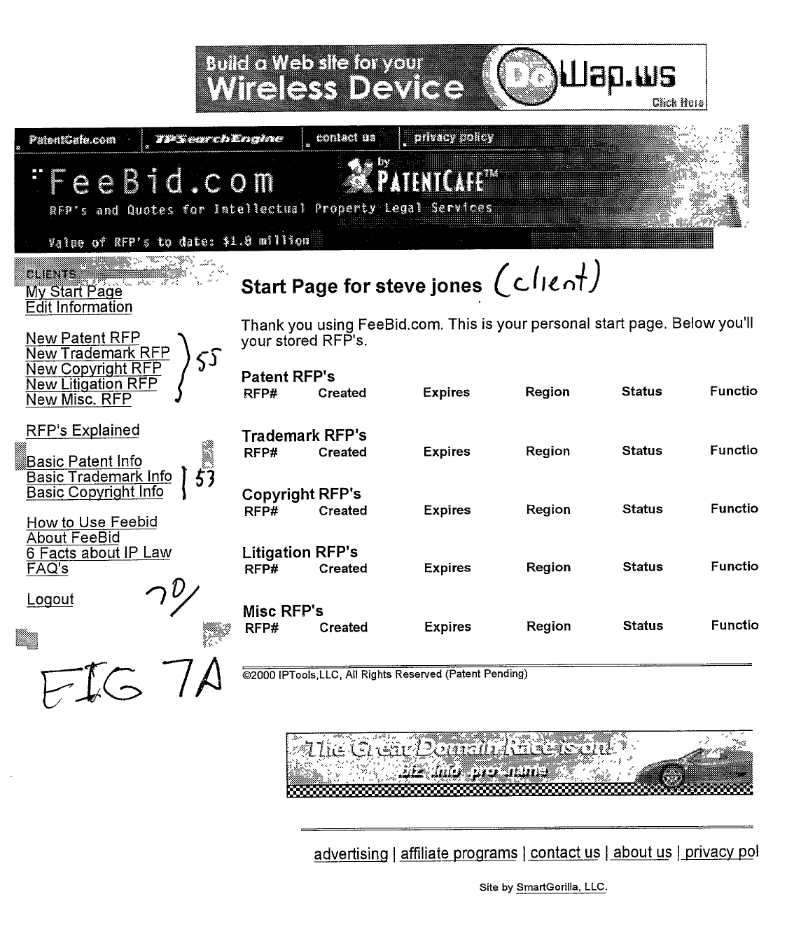

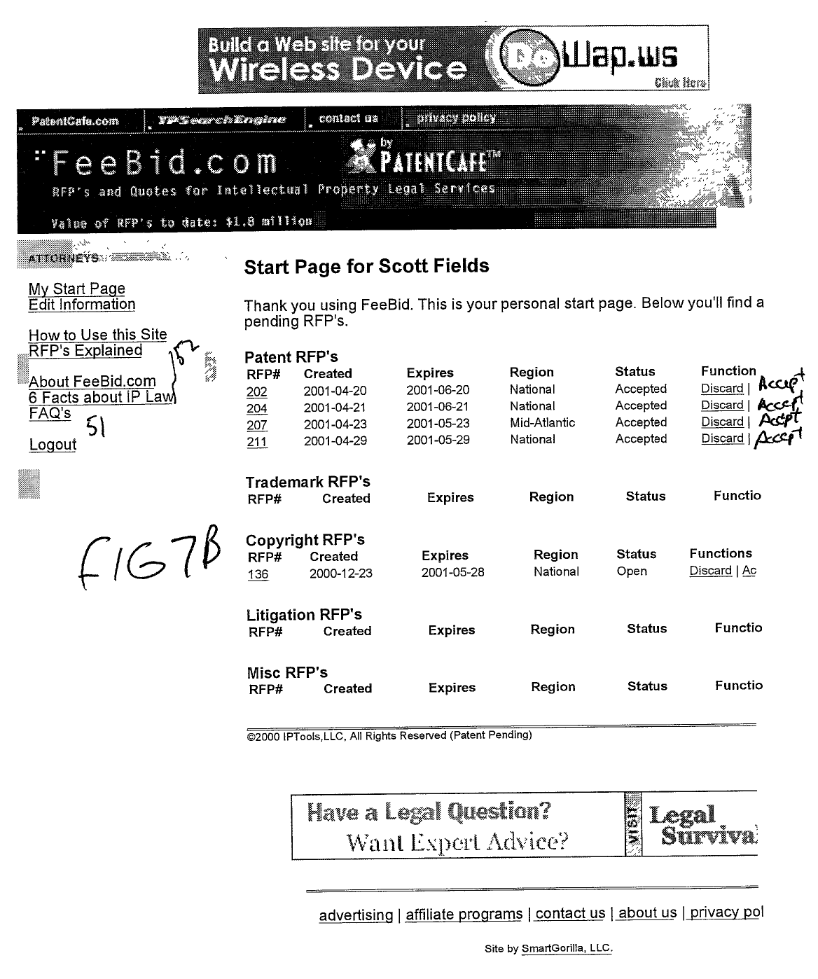

FIG. 5 illustrates the terms of service 30 to which the client must agree in order to access the service. As shown, FIG. 4 includes an input screen where the end user inputs a user name and password 42. If the client is a new user and has no user name and password, he is then taken to the screen shown in FIG. 6 that comprises a client intake form or screen 44. The intake screen 44 comprises a plurality of user data fields 46 in which the client inputs individual address and demographic information about himself/herself and his/her business. As will be discussed below, it is advisable that the user input his state 48 as a pull down screen, because the state of the end user, which defines the end user's geographic region, is important with respect to the generation of a regional fee proposal, as will be discussed herein.

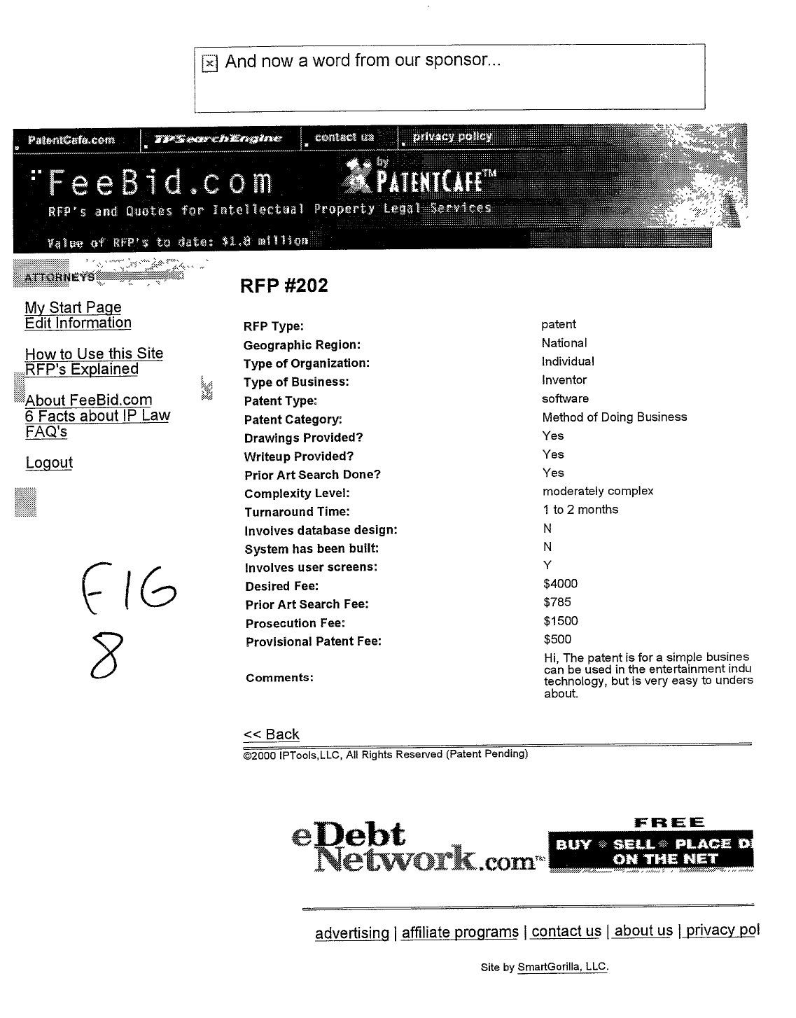

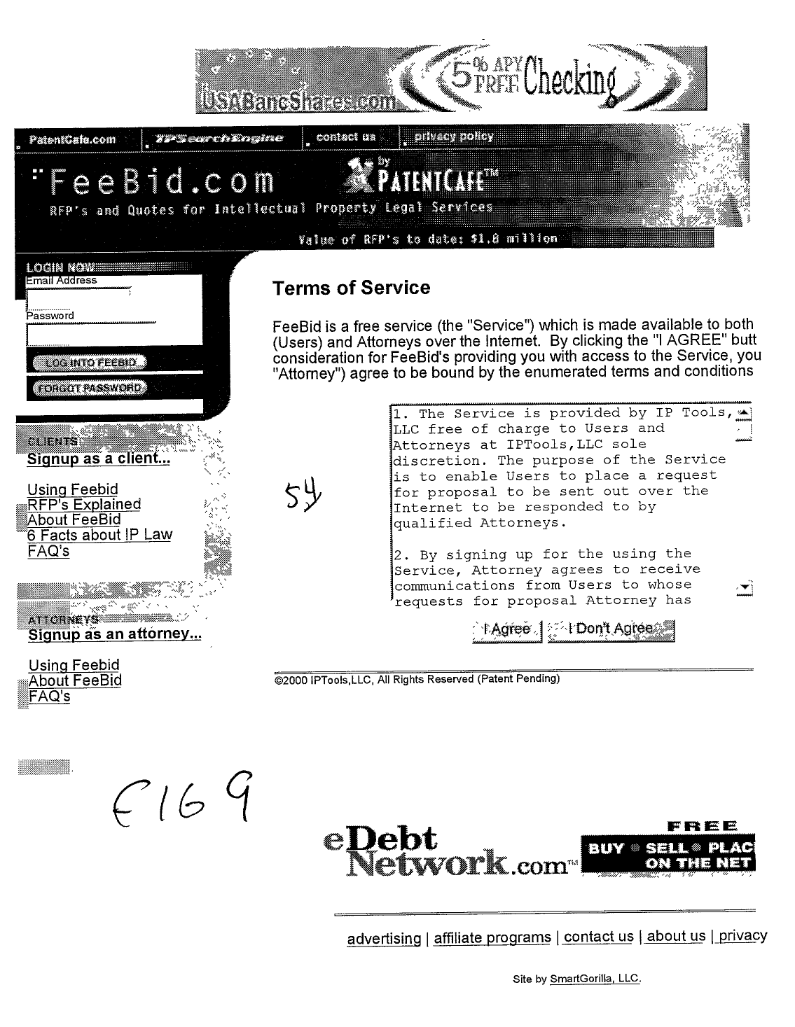

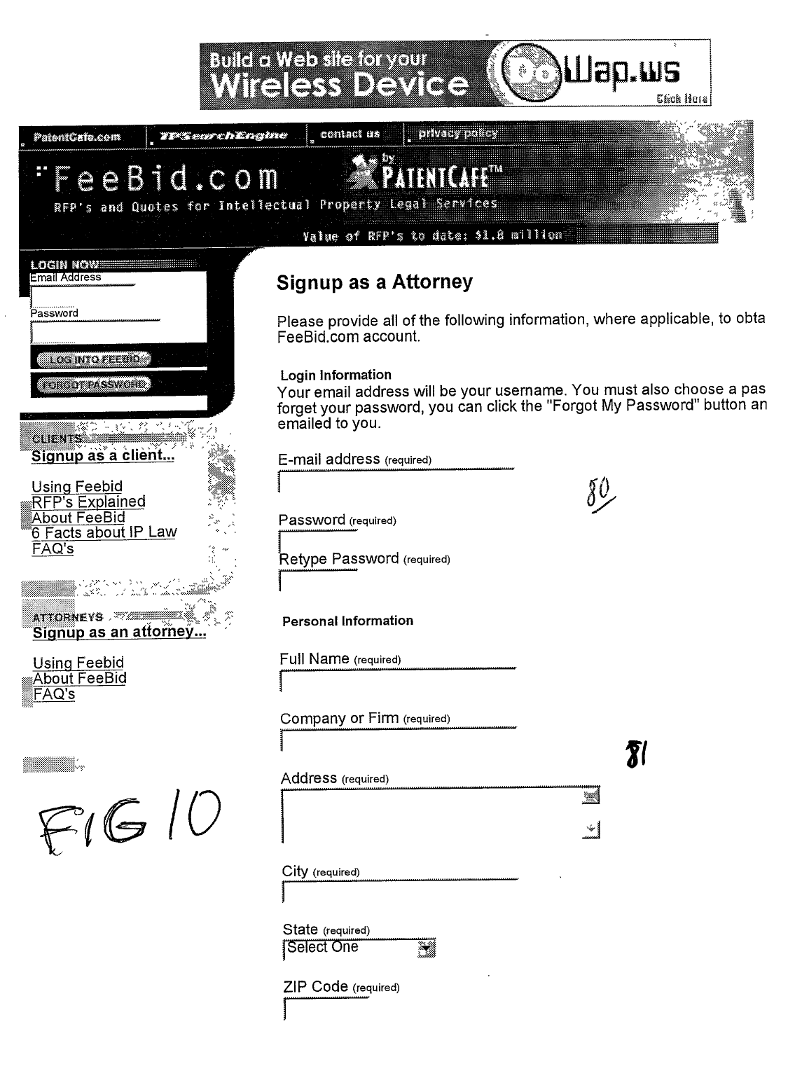

Concurrently, with inputting the requisite client information, as shown in FIG. 6, the client chooses his user name and password 50 and may access further features of the system from his member Start Page 70. The “Start Page” shown in FIG. 7A will serve as the home page 70 for the client within the site. It will comprise the place on the website which the client can check to see new RFP responses and to check the biographies of attorneys who have responded to client RFP's. The methodology by which a client creates an RFP is disclosed. In the preferred embodiment, which is directed to a site and technology for creating IP legal services, the client is afforded the opportunity to place an RFP for Patent, Trademark, Copyright, Litigation and Miscellaneous related IP services from the start page. These Start Pages may include links 53 to basic information on patent, trademark and copyright law. FIG. 7A thus includes the basic entrance area 55 to the fee formulator which will be describe in greater detail below.

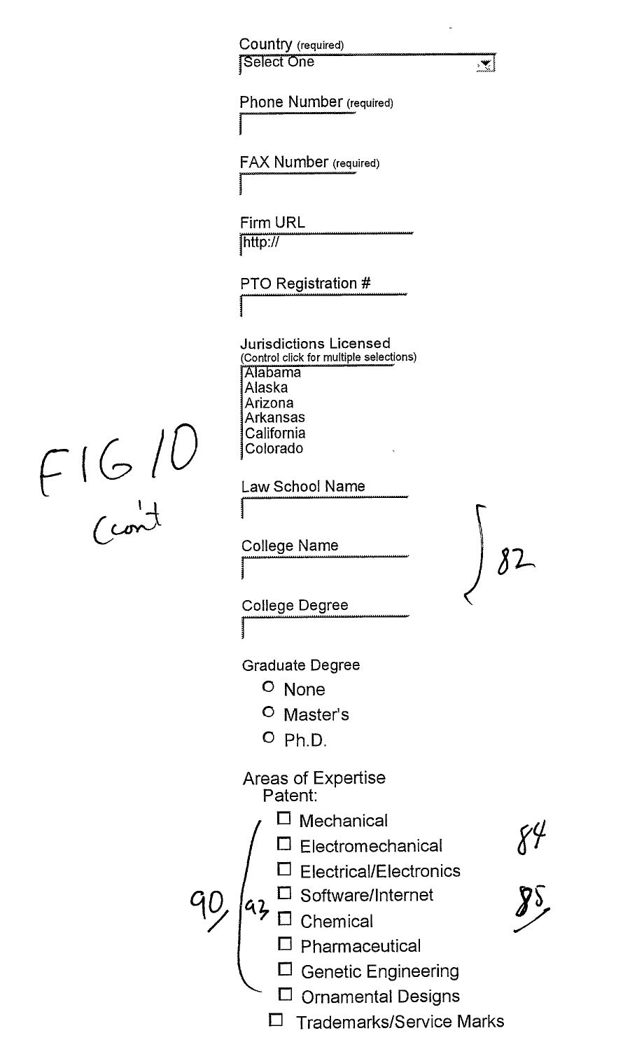

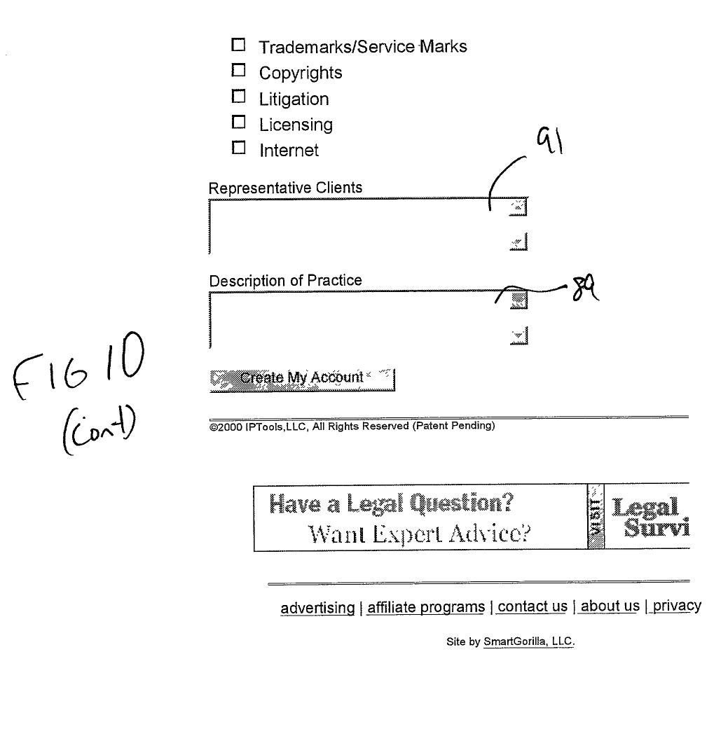

As shown in FIG. 7B, an attorney Start Page 56B end is shown and described. FIG. 7B is analogous to the Start Page of FIG. 7A and provides the attorney with a basic text introduction to the service. An attorney frequently asked question section (FAQ) 51 and promotional or explanatory information 52 is also provided. The attorney will also be provided with a terms of service page 54 at FIG. 9. The attorney Start Page also lists and sets forth the status of the RFPs including their category, RFP#, expiration date, Region and Status. FIG. 8 illustrates the information that is provided on an RFP. Like the client Start Page, the attorney Start Page lists the RFPs by number which have been posted to the attorney's account. Each RFP has a number and by hitting a hyperlink, the RFP is presented as shown in FIG. 8.

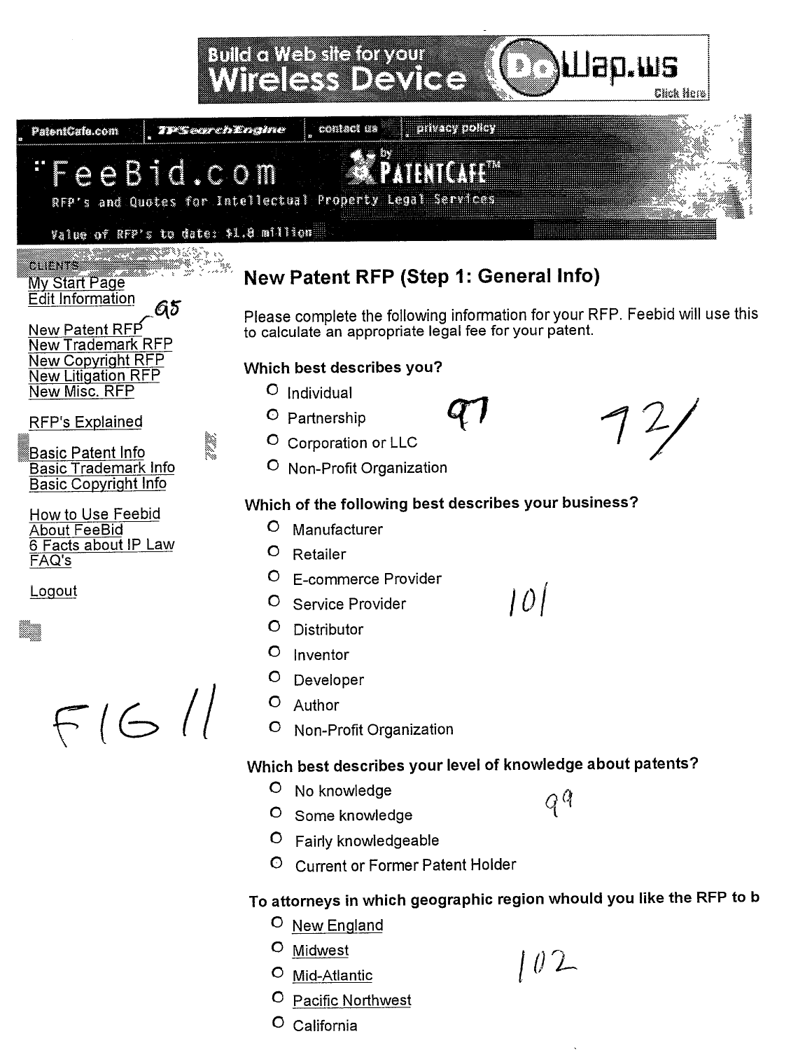

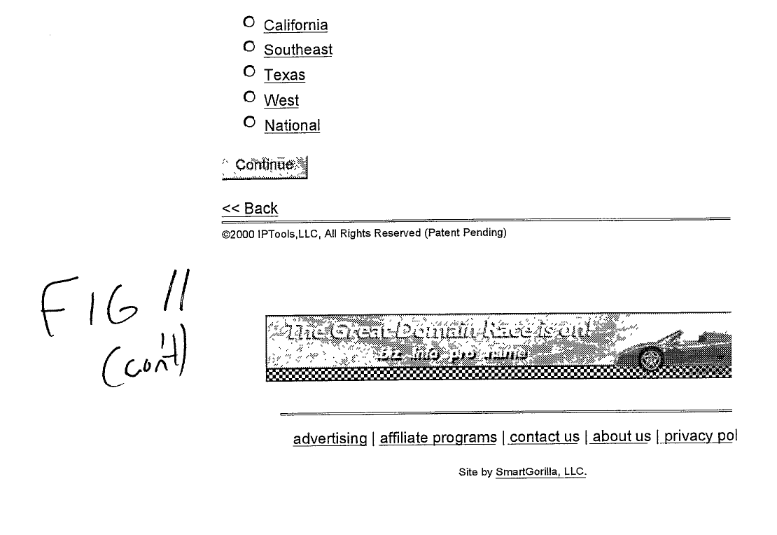

As shown in FIG. 4, after the attorney registers, the attorney is asked to place his name and password into the system 42. This will take the attorney to his Start Page of FIG. 7B. If the attorney has no password, he is taken to a screen illustrated at FIG. 9, where he agrees to the terms of use and then to an attorney intake or registration form 80 shown in FIG. 10. The intake form will request the attorney to choose an email address and password and request such information as the attorney's address 81, level of education 82, experience 84 and fields of expertise 85. The intake form will preferably include a field 87 at the bottom of the screen whereby the attorney can place narrative information about himself and his practice 89 and list representative clients 91. Some of the fields of the input screen, such as fields of expertise 85 are important, because as will be discussed further, they may provide basic database information by which the client can control the dissemination of the request for proposal (RFP).

Areas of professional expertise are preferably set out as form inputs for patent, trademark and copyright related matters 90. The attorney intake screen 80 further has fields 92 in which to set out respective technical sub-specialties of patent law which are included in the proposal generation system, i.e., mechanical, electro-mechanical, software, software/lnternet/business method, pharmaceutical, genetic, chemical, and ornamental design. As shown in FIG. 4, the attorney who registers can then access the site his user name and password 53, 54

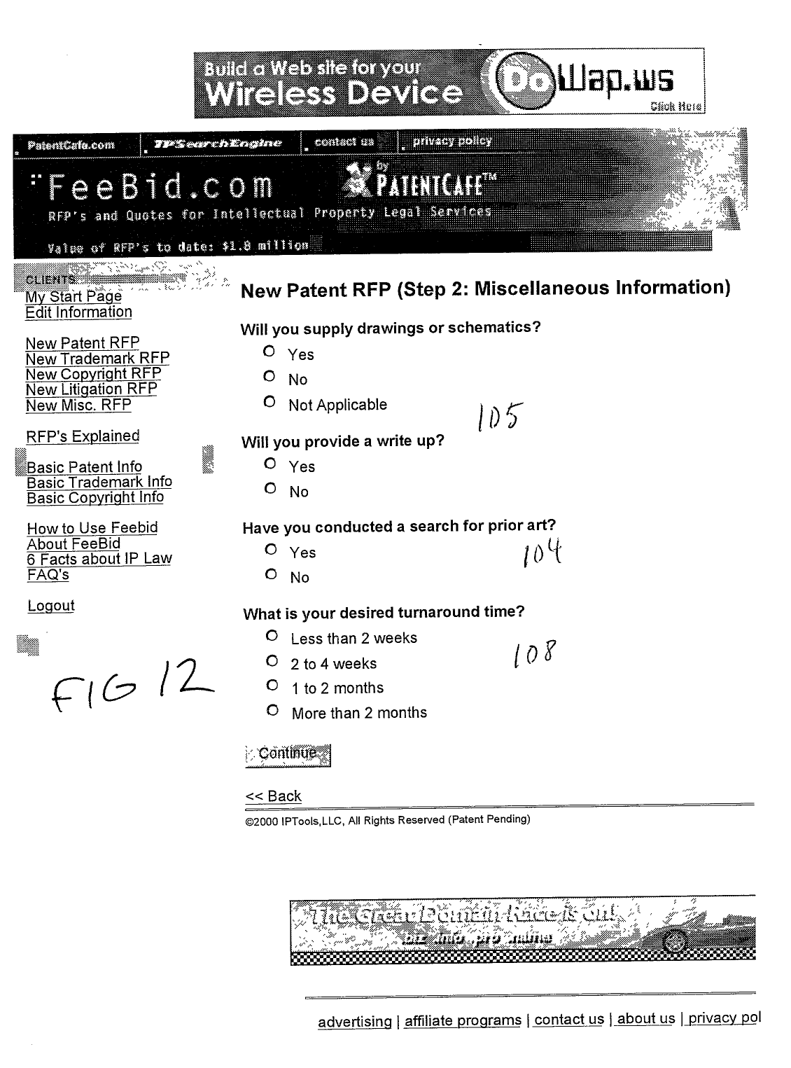

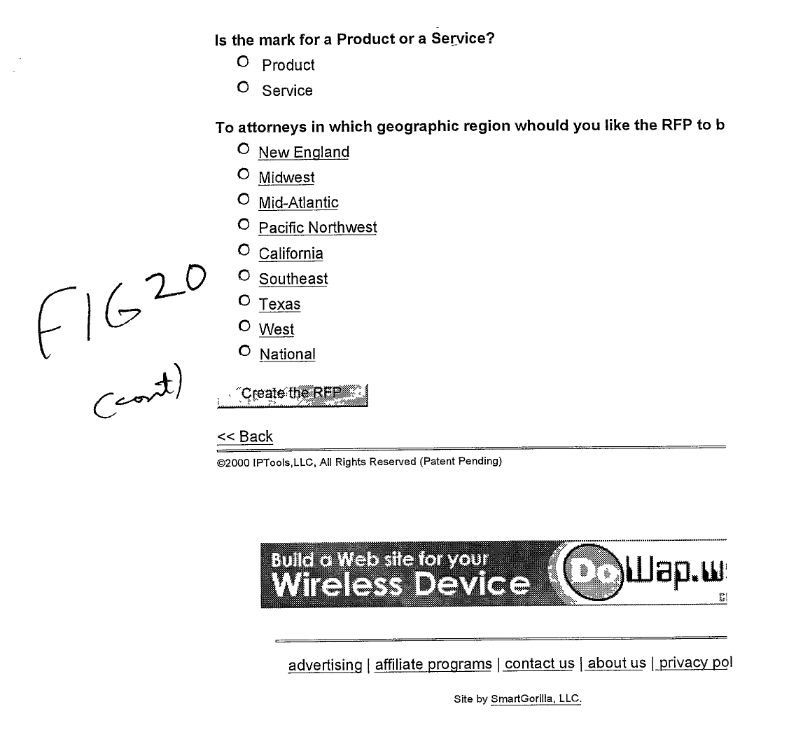

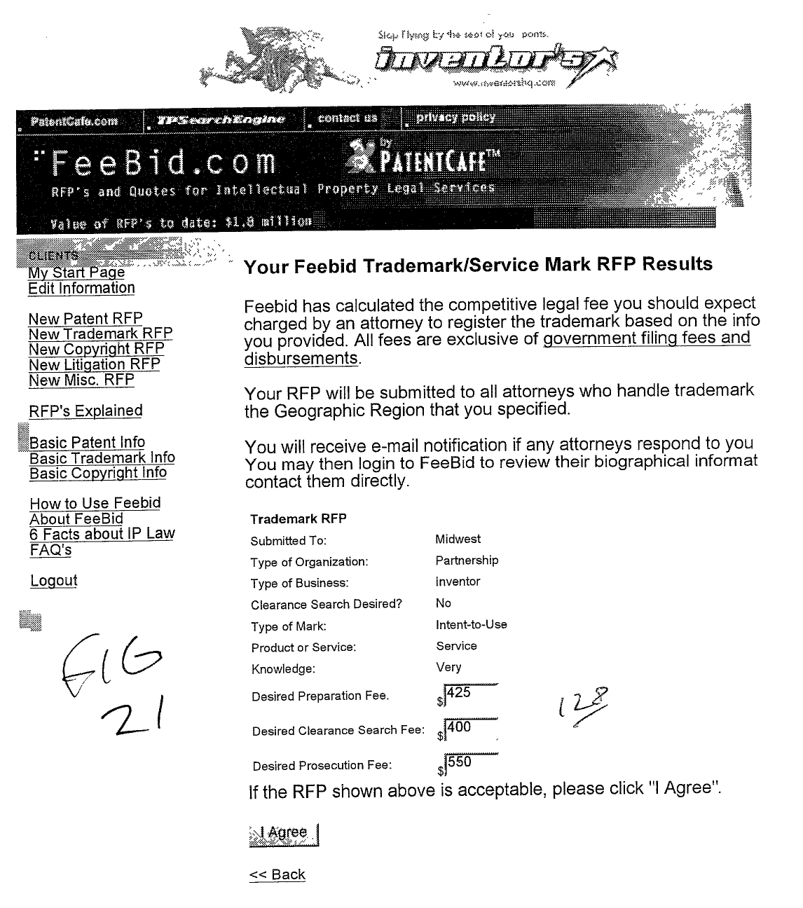

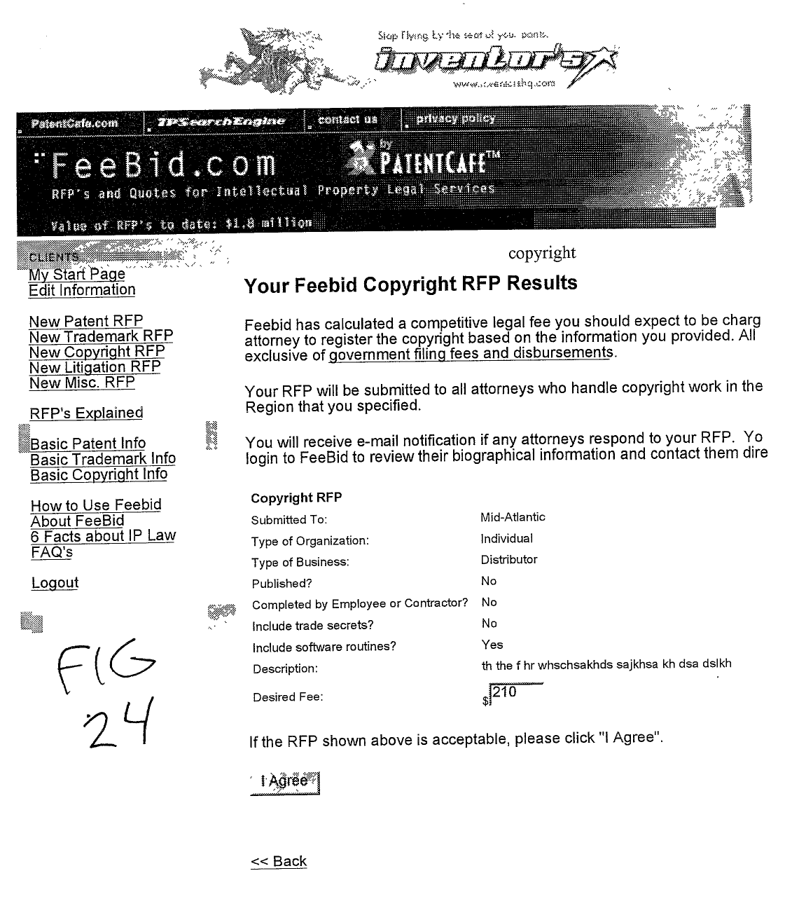

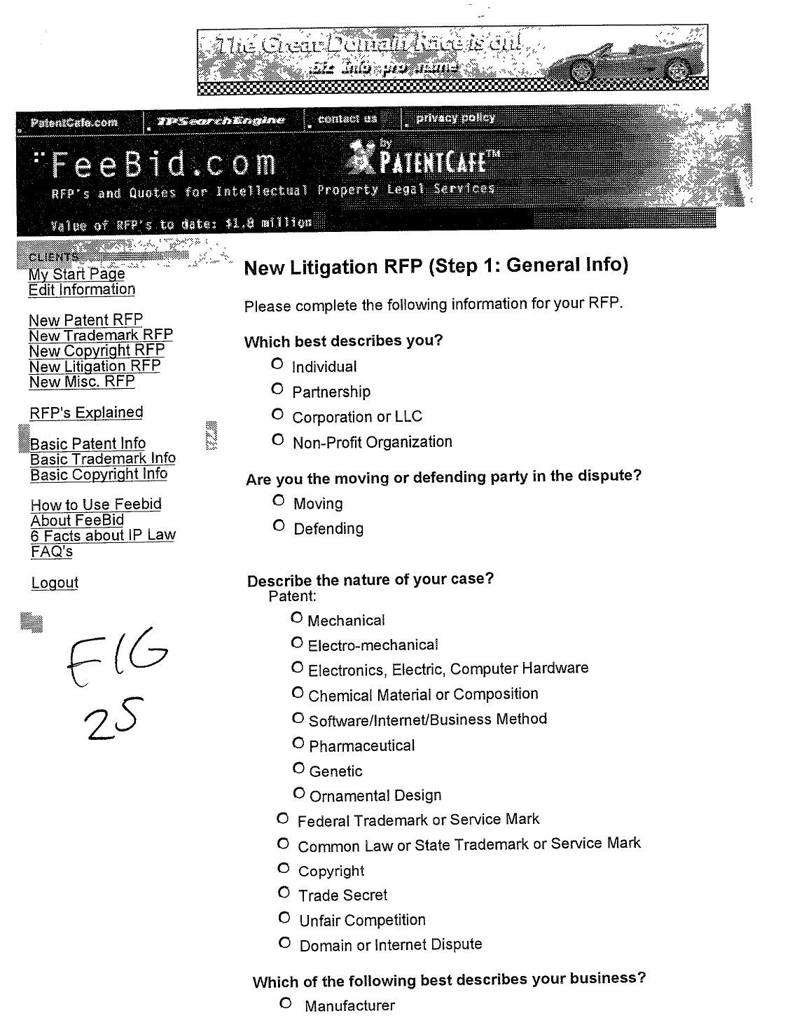

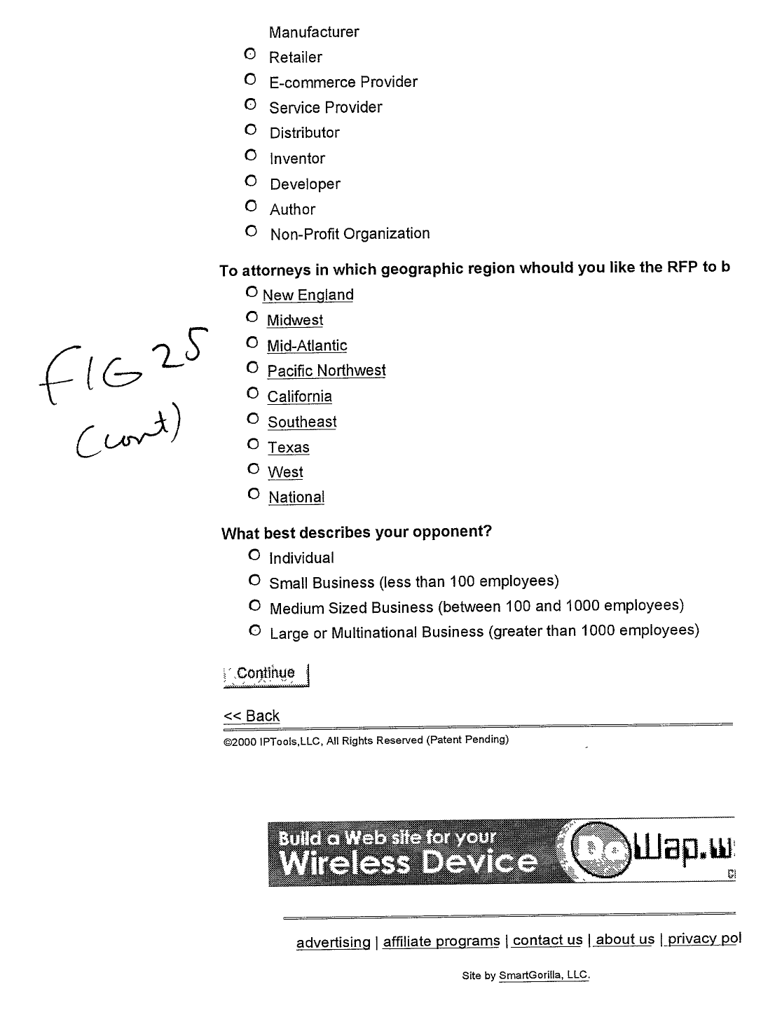

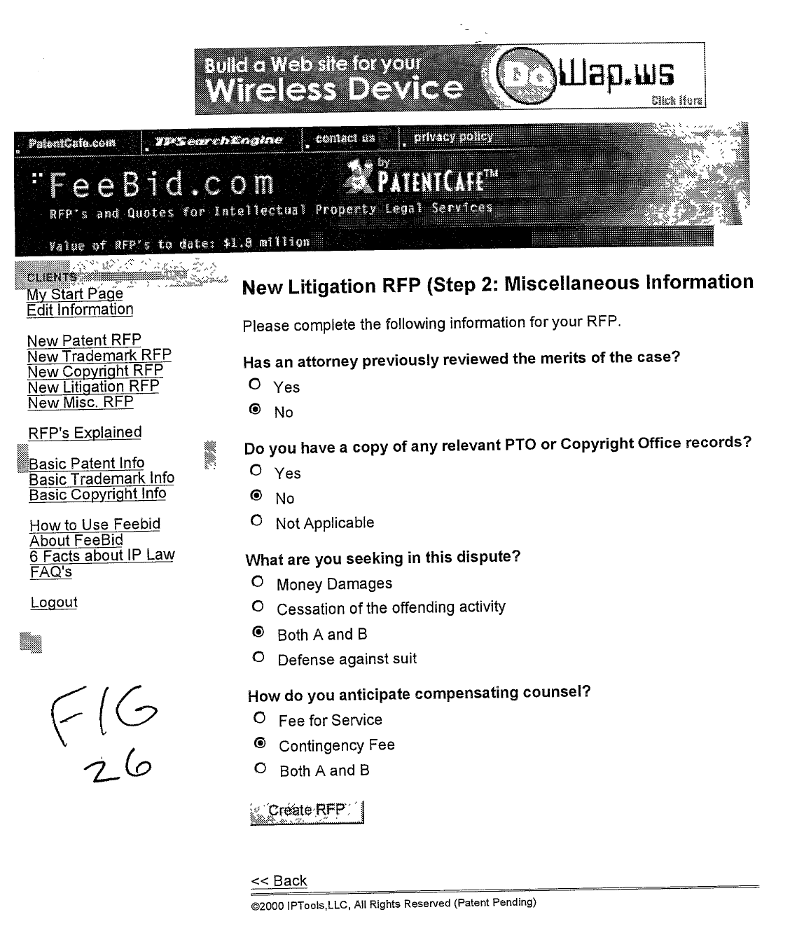

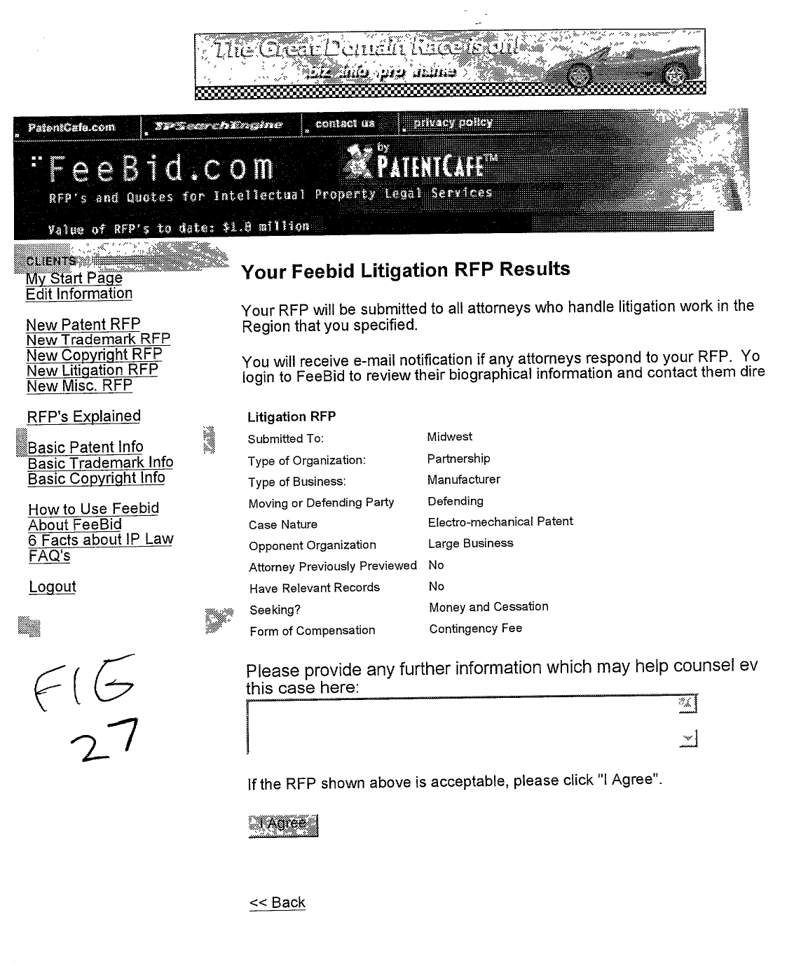

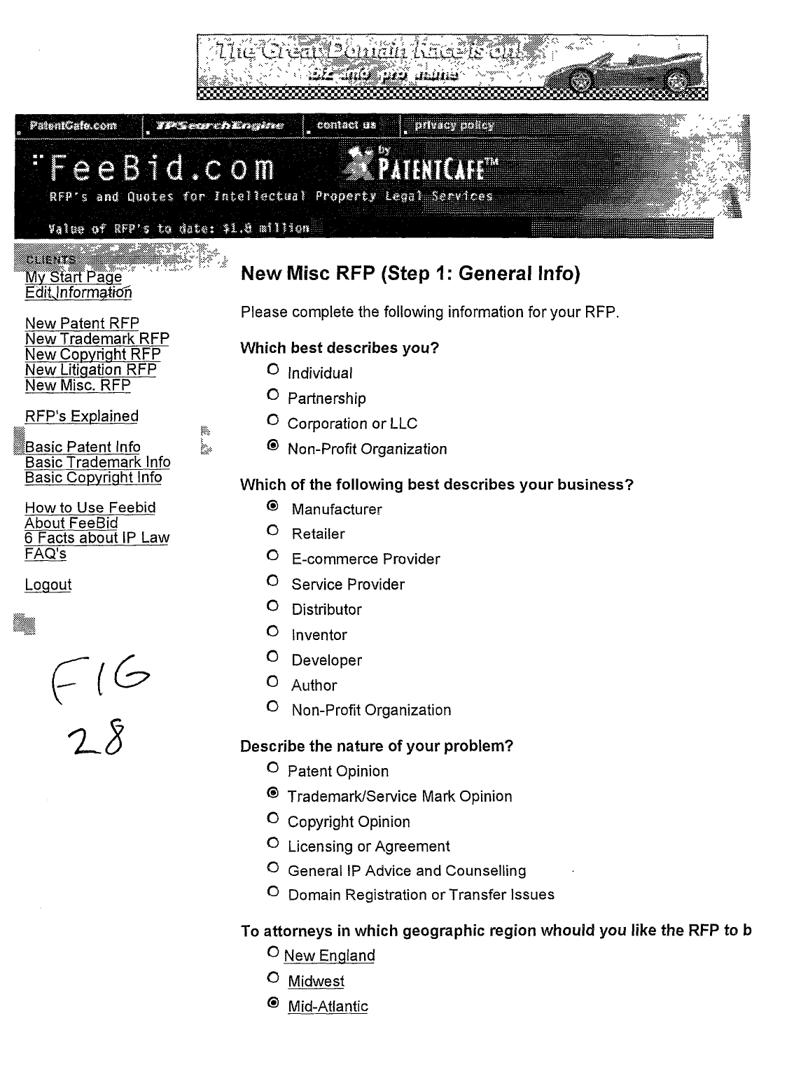

Referring now to FIGS. 11 to 29A, the components for generating a fee proposal and request by the client are set out in detail. These screens are used by the client in generating his request for proposal. Initially, as noted above, at the Start Page of FIG. 7A, the client designates the type of services a client desires, e.g. patent, trademark, copyright, litigation or miscellaneous 55. The client then goes to the proposal and fee formulator 72 shown collectively in FIGS. 11 to 29A.

The proposal and fee formulator 72 is the heart of the system and will assist clients in formulating their request for proposal for a variety of legal services. The proposal and fee formulator comprises a series of input screens supported by a back end application.

Referring to FIGS. 11 to 19A, the patent fee formulators are shown. The formulators comprise a series of sequential user screens (FIGS. 11 to 19A) that will assist the client in formulating an RFP for a particular type of patent matter. The patent fee formulator is accessed by the client choosing “NEW PATENT RFP” 95 from the Start Page.

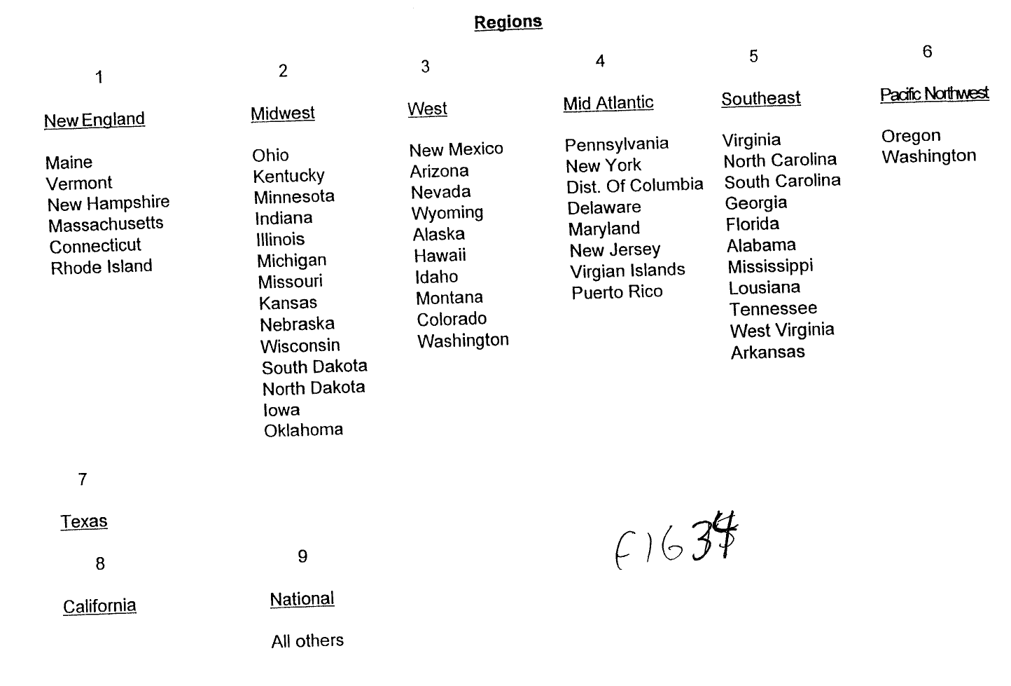

As shown in FIGS. 11 to 19A, the Patent Fee formulators comprise a sequential series of user screens which produce an RFP including a customized fee quote. As shown in FIG. 11, in the initial screen designated by “Step 1”, the client is requested to provide general information such as whether the client is an individual, corporation or partnership 97 and whether the client has knowledge of the patent system 99, thereby establishing the client's level of knowledge and sophistication 100, the nature of the client's business 101 and the region where the client desires to send the RFP 102. In one embodiment as shown in FIG. 34, the present invention is broken down into 9 geographic regions.

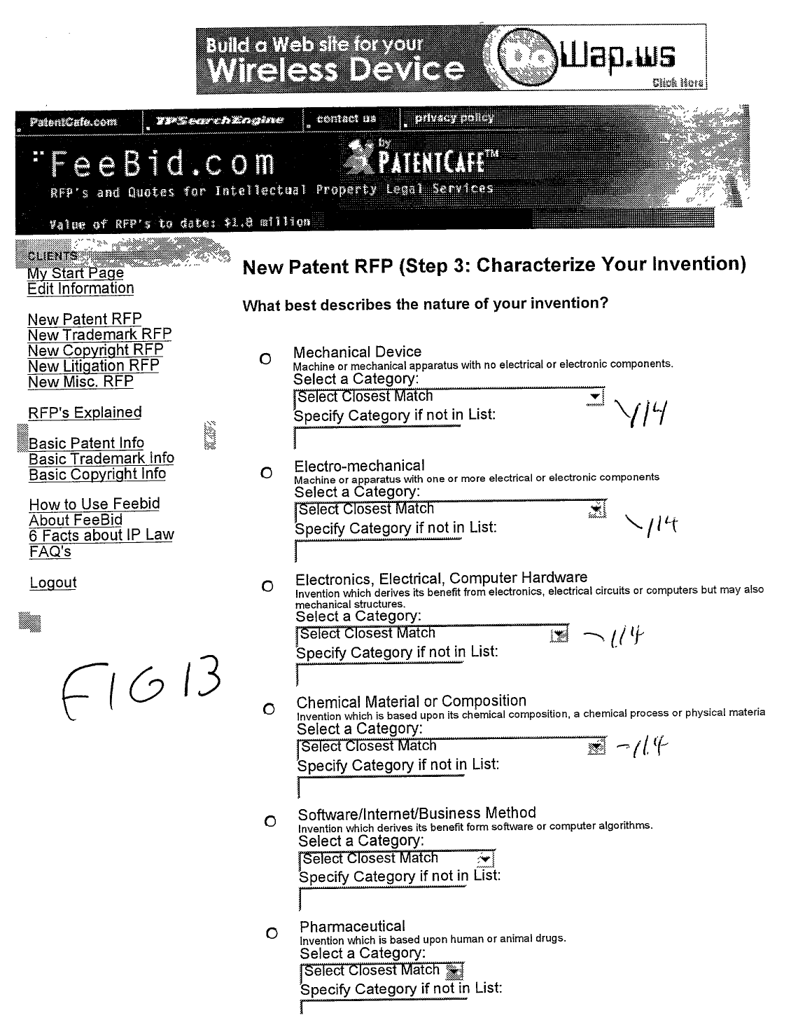

The client is then taken to a next to a screen and FIG. 12 where he provides miscellaneous information including the existence of a writeup and drawings 105, the existence of a prior art search 104 and the client's turnaround requirements 108. These questions are critical because they relate to the percentage or dollar value penalty or discount factors to be applied to the project . For example, the job of an intellectual property practitioner is far easier when he is provided with a write up and is provided with more time to complete the task.

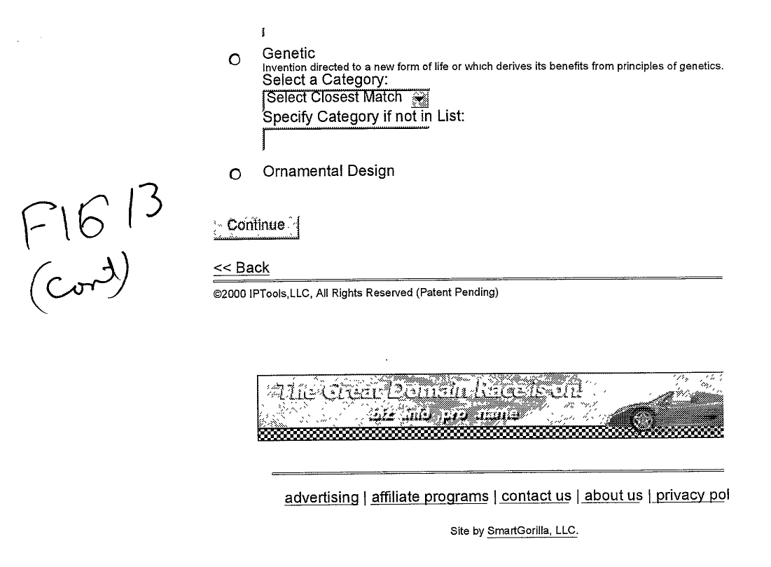

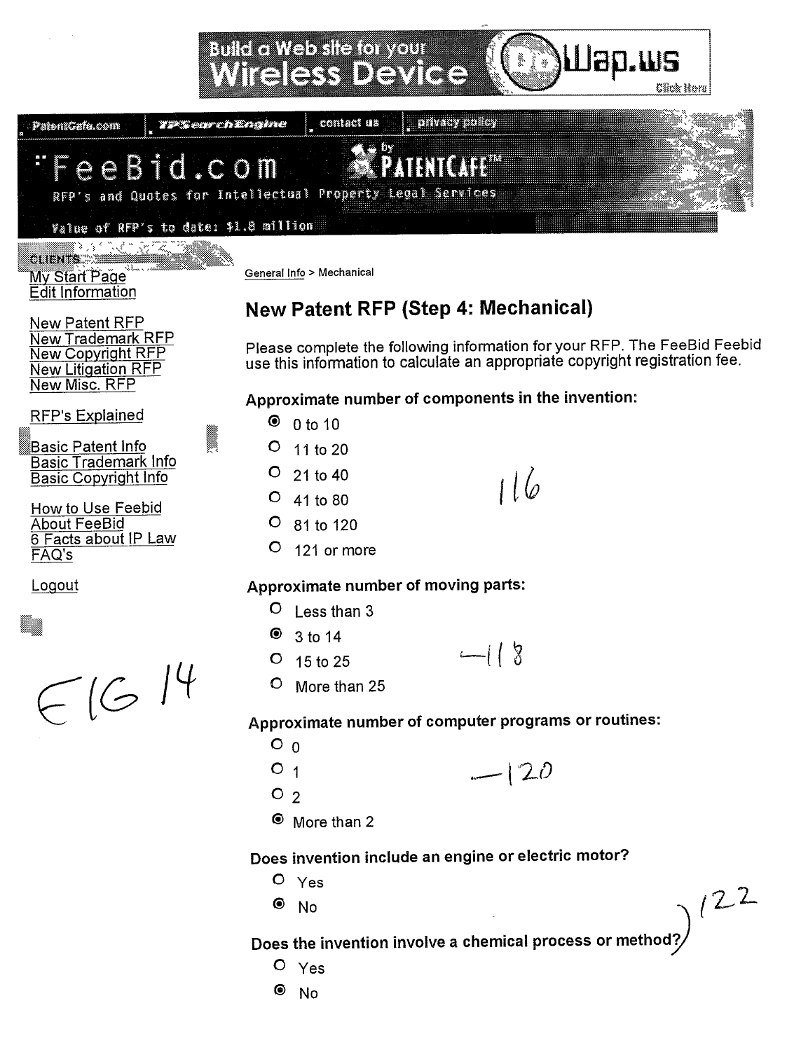

Next, as shown in FIG. 13, the client is then requested to characterize the invention according to one of eight categories. Each of the categories is provided with a pull down screen 114 by which the client can pick a more specific descriptor of the invention, or alternatively, write one in. It is to be appreciated that more or fewer categories may be created and that the above categories are merely exemplary. For example, categories could be chosen based upon SIC codes or the table of classification which is utilized by the U.S. Patent & Trademark Office in categorizing patents.

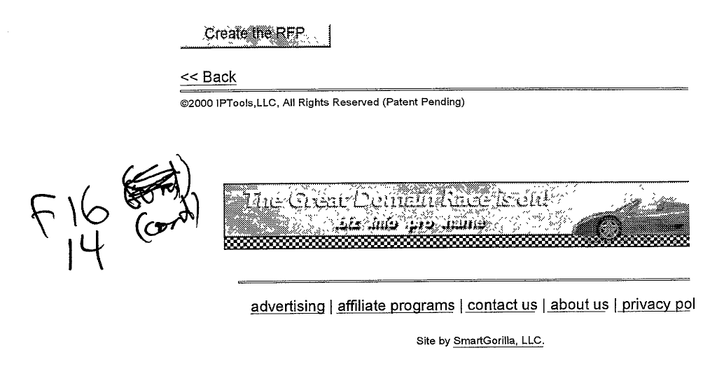

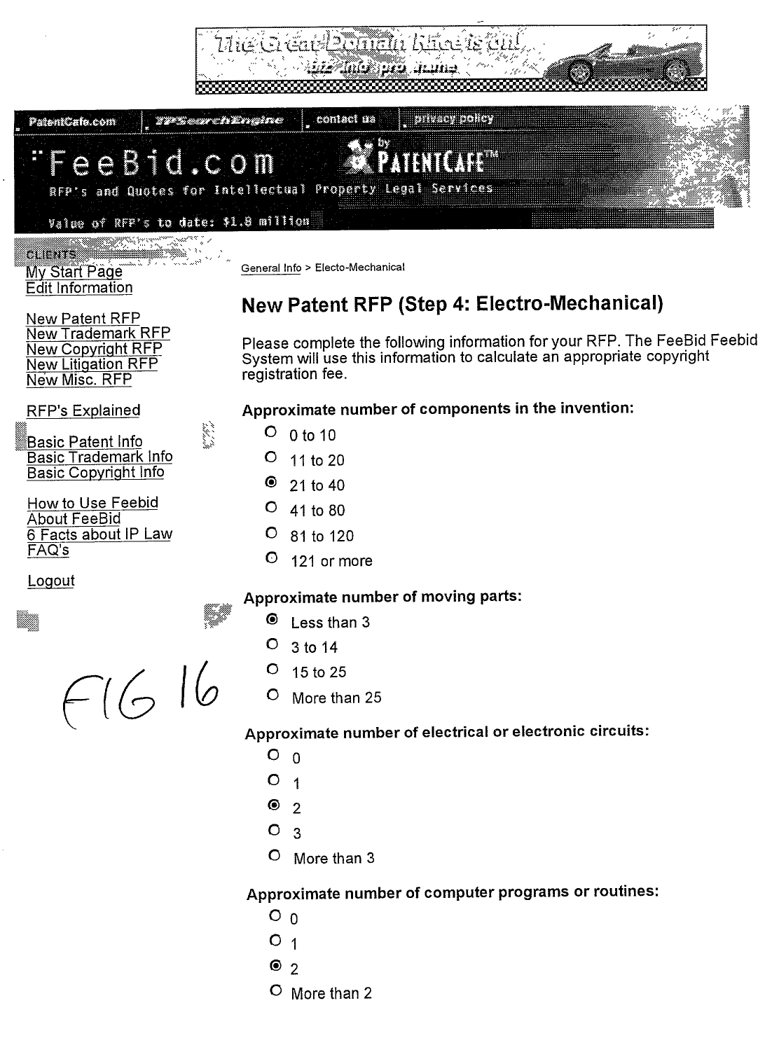

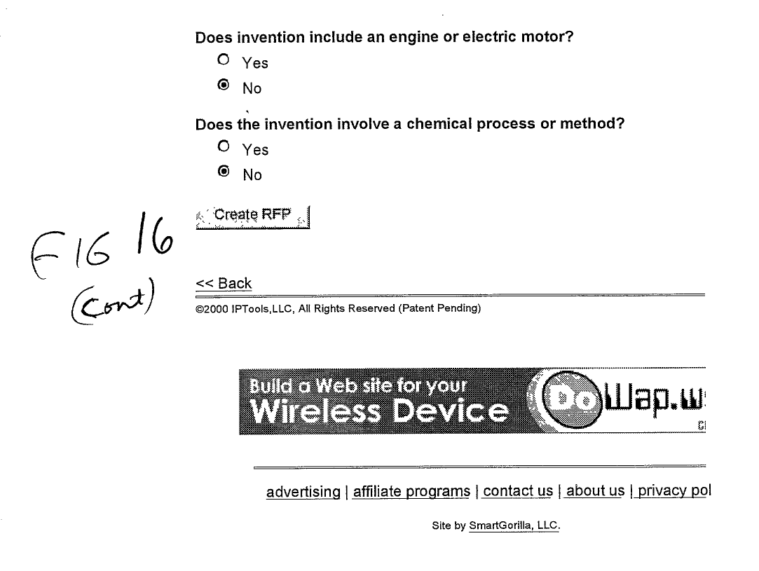

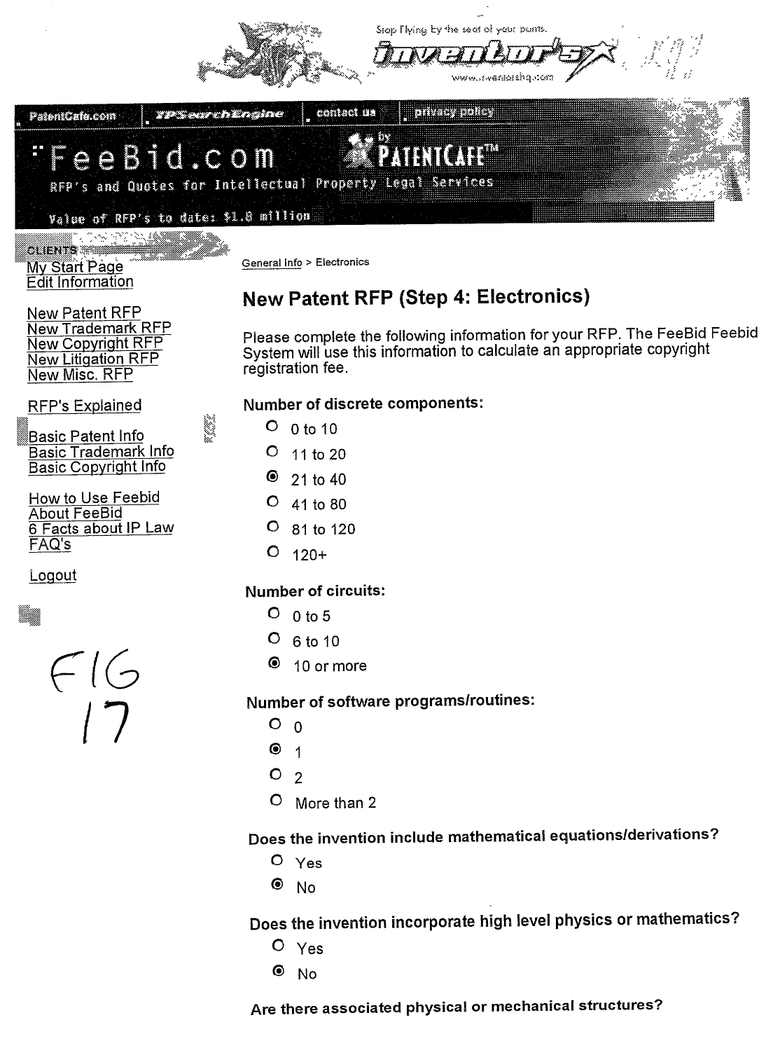

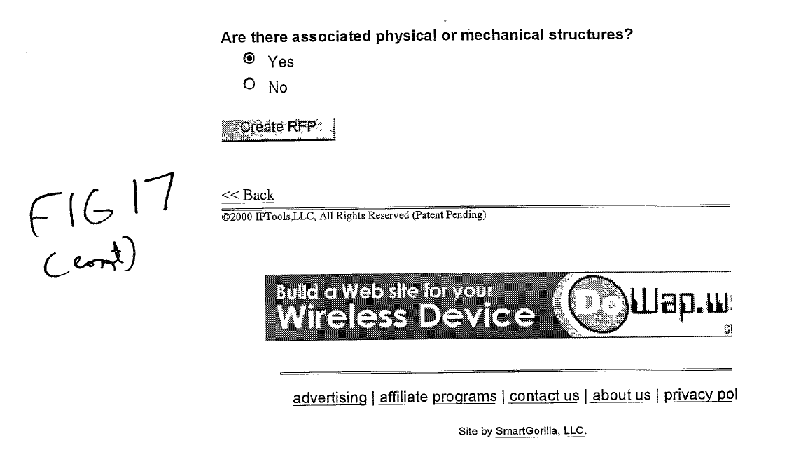

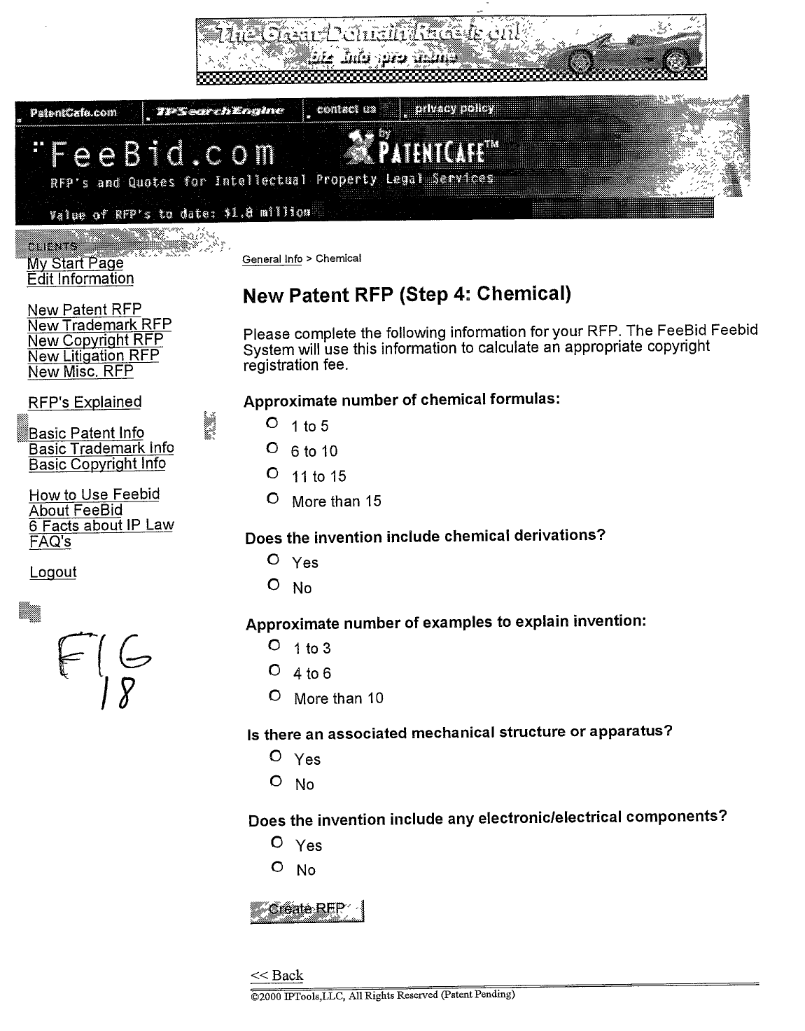

FIGS. 14 to 19 then illustrate the respective questions which the client is then asked to answer various questions for each of the categories chosen. As shown in FIG. 14 for example, the client is asked to answer specific questions related to a Mechanical invention. Each of these questions is used to evaluate the complexity of the invention and to add respective dollar values to the ultimate fee quote. For example, FIG. 14 asks the client to designate the number of components 116, the number of moving parts 118, the existent or non-existence of computer programs 120, motors and chemical processes 122. FIGS. 16 to 19 request similar type questions geared to the technological issues present by each respective type of invention. For example, in the Electonics RFP formulator of FIG. 17, the client is requested to designate the number of electronic components and circuits and the existence of mathematical equations and high level mathematics; in the Chemical RFP Formulator of FIG. 18, the client is asked to designate the number of chemical formulas and derivations; in the Software Formulator of FIG. 18A, the number of routines and the relevance of database design; and in the Pharmaceutical Formulator of FIG. 19, the number of formulas, examples and whether a method of preparation is included.

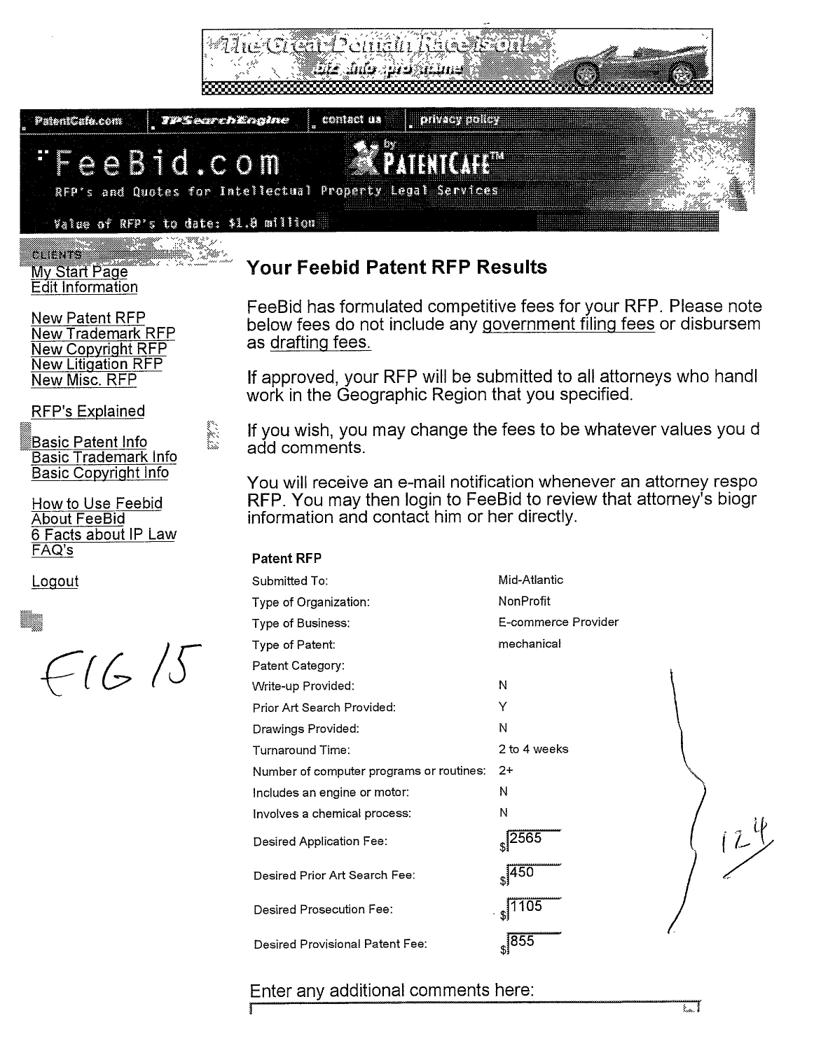

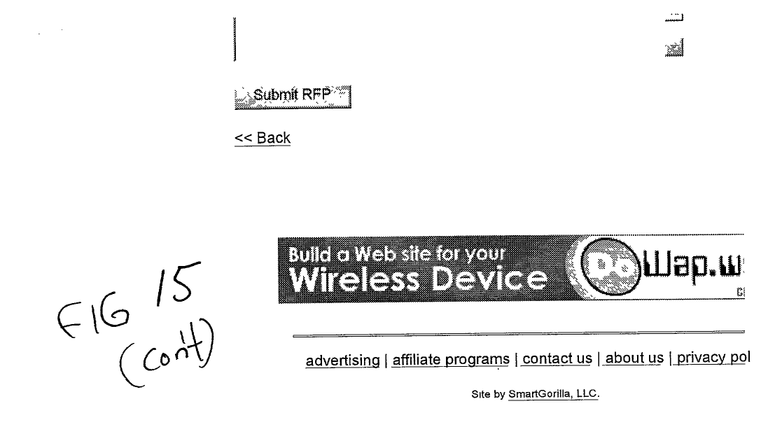

FIG. 15 illustrates the generated RFP results from an example Mechanical RFP shown in FIG. 14. As shown, the RFP derives information taken from the screens of FIGS. 11 to 14 and further includes a proposed fee quote patent preparation, prosecution, prior art search and provisional fee patent 124.

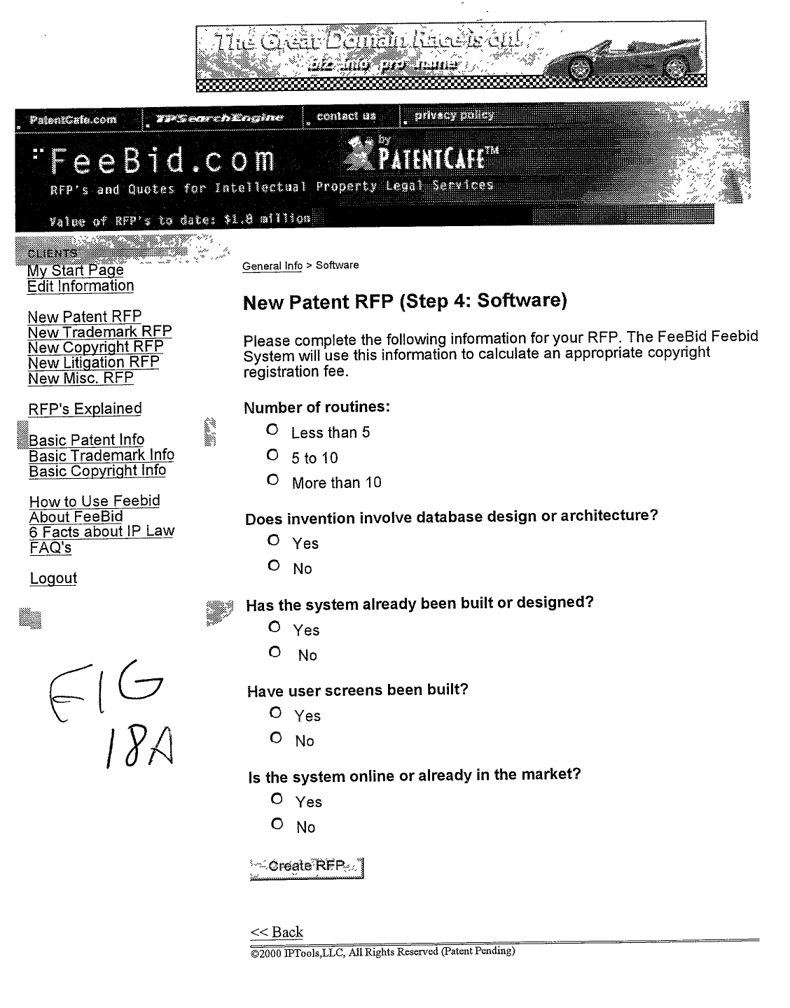

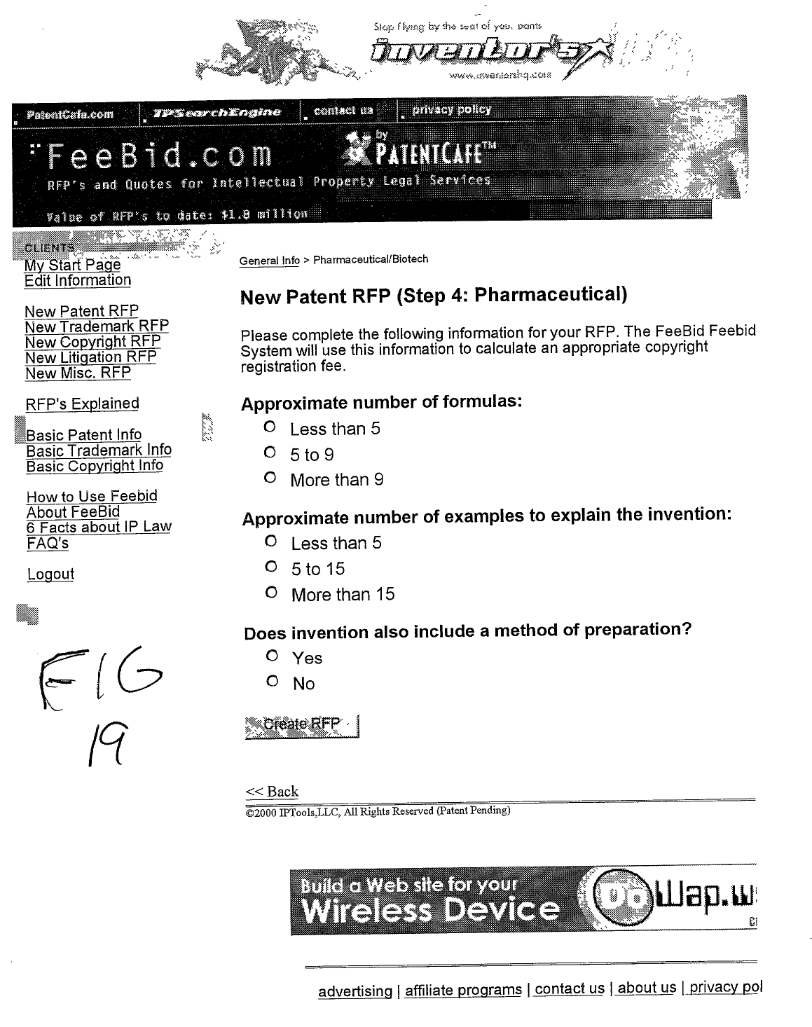

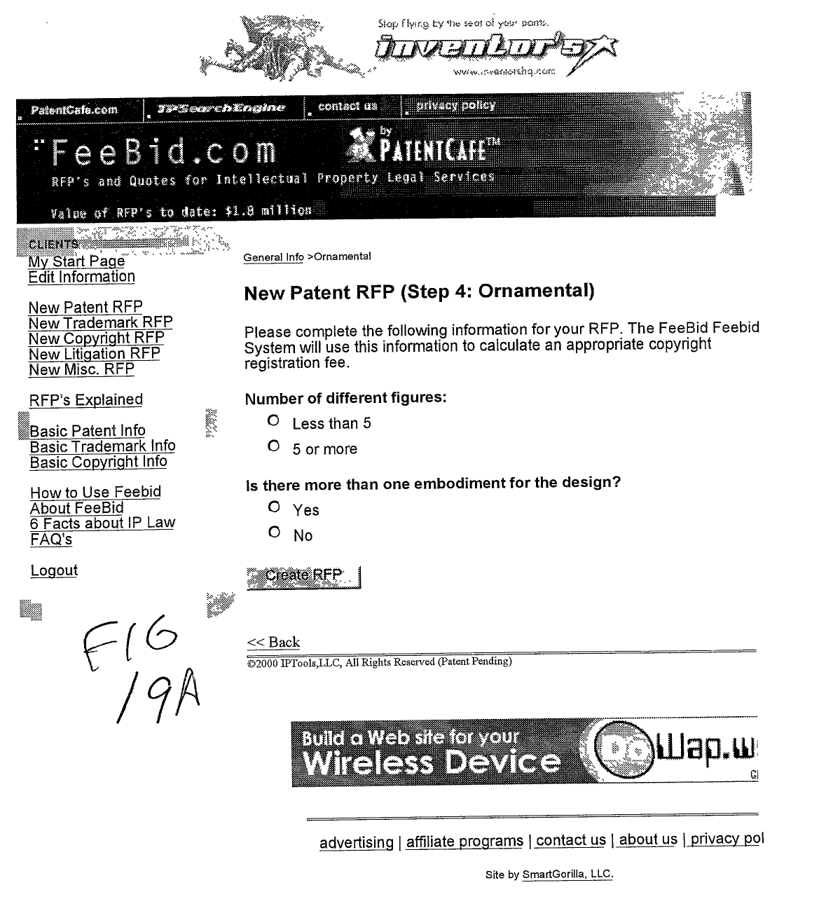

FIGS. 20 to 24 illustrate the input screen for generating RFPs for trademarks and copyrights. FIGS. 20 and 21 illustrate the screen used for generating an RFP for a trademark/service mark registration. As shown, the system collects basic information about the client, the desired geographic region, and whether the mark is a use or intent-to-use registration 126. FIG. 21 illustrates the generated RFP which can then be accepted. The client is provided with fees for clearance, registration and prosecution 128.

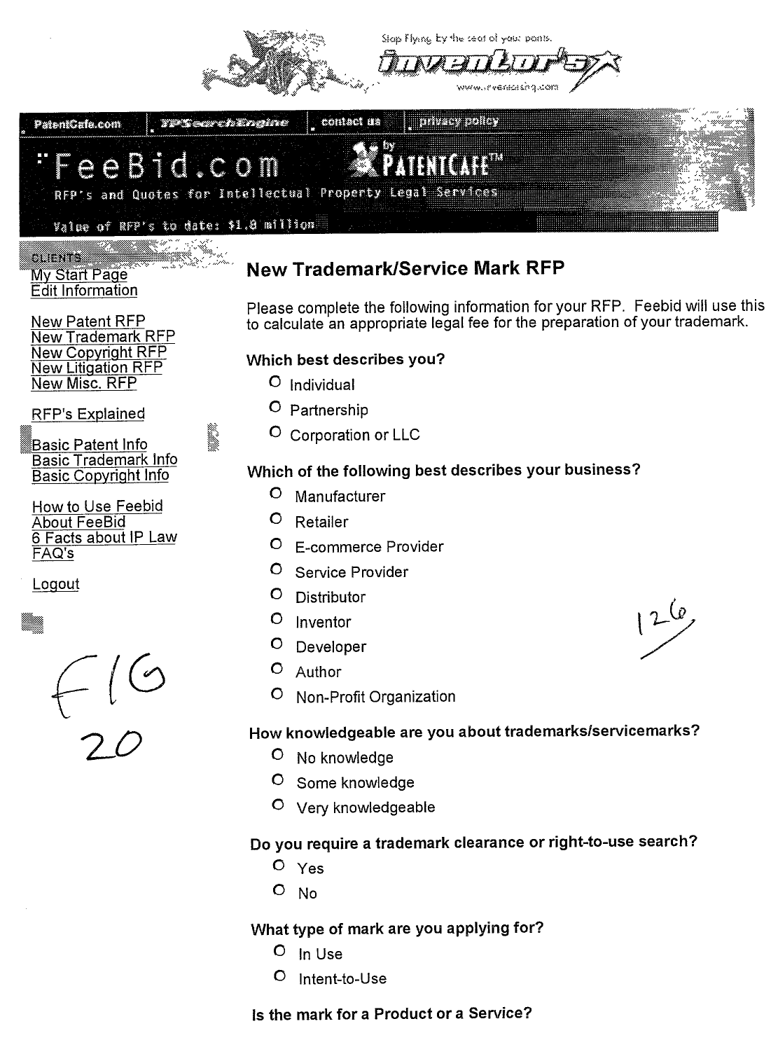

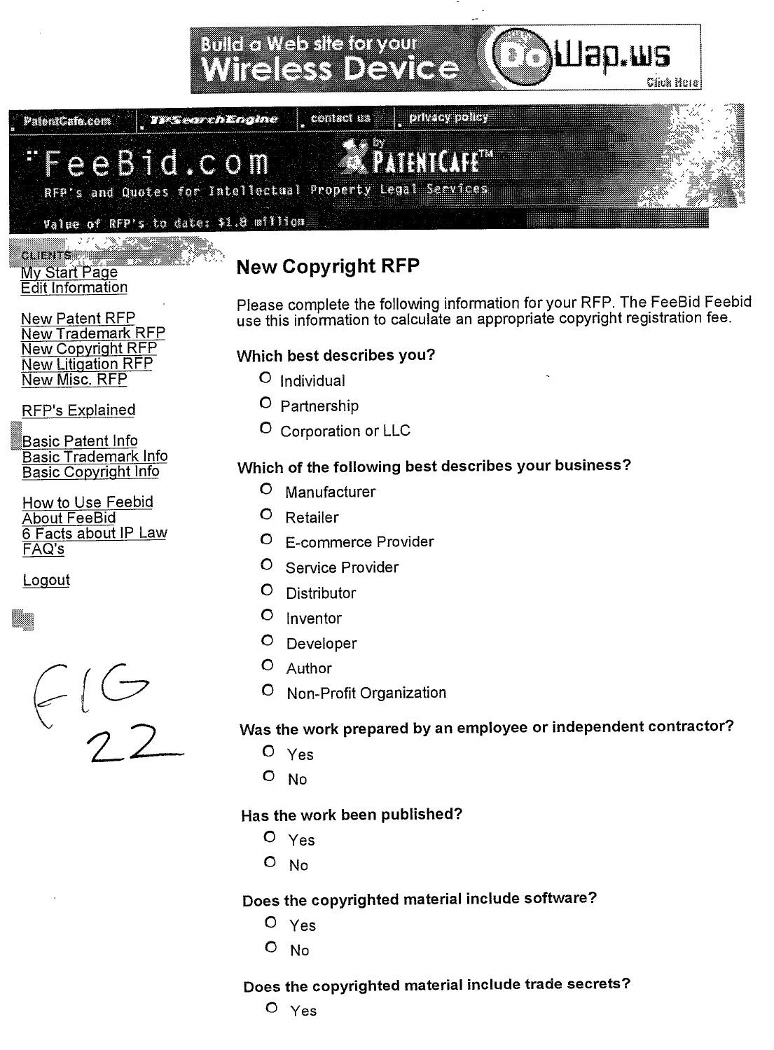

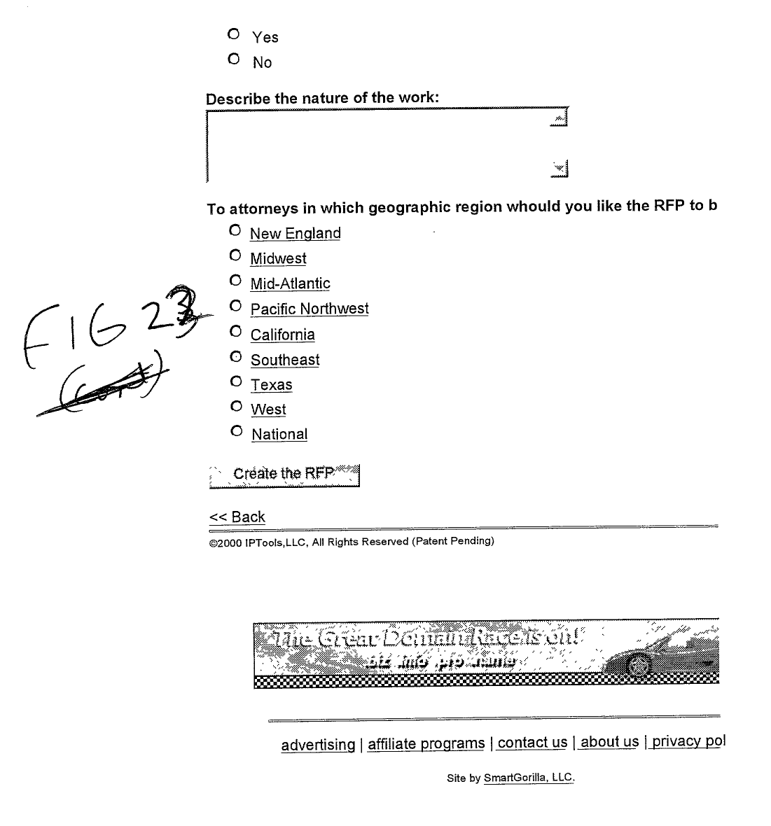

Referring to FIGS. 22 to 24, a copyright RFP formulator is shown. Here the client is asked to designate whether the work is published, includes software and trade secrets. The client is further asked to designate a region where the RFP is to be distributed. FIG. 24 illustrates the generated RFP. If the client hits “I Agree” it is placed in his Start Box and attorney will be notified of the new RFP. FIGS. 25 to 29A illustrate RFP Formulators for IP litigation and Miscellaneous services. The client is asked to input information related to the case or desired project.

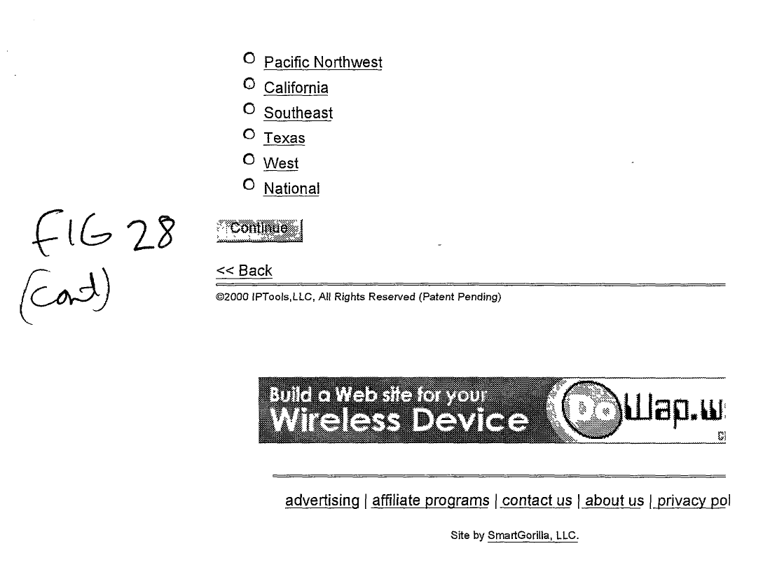

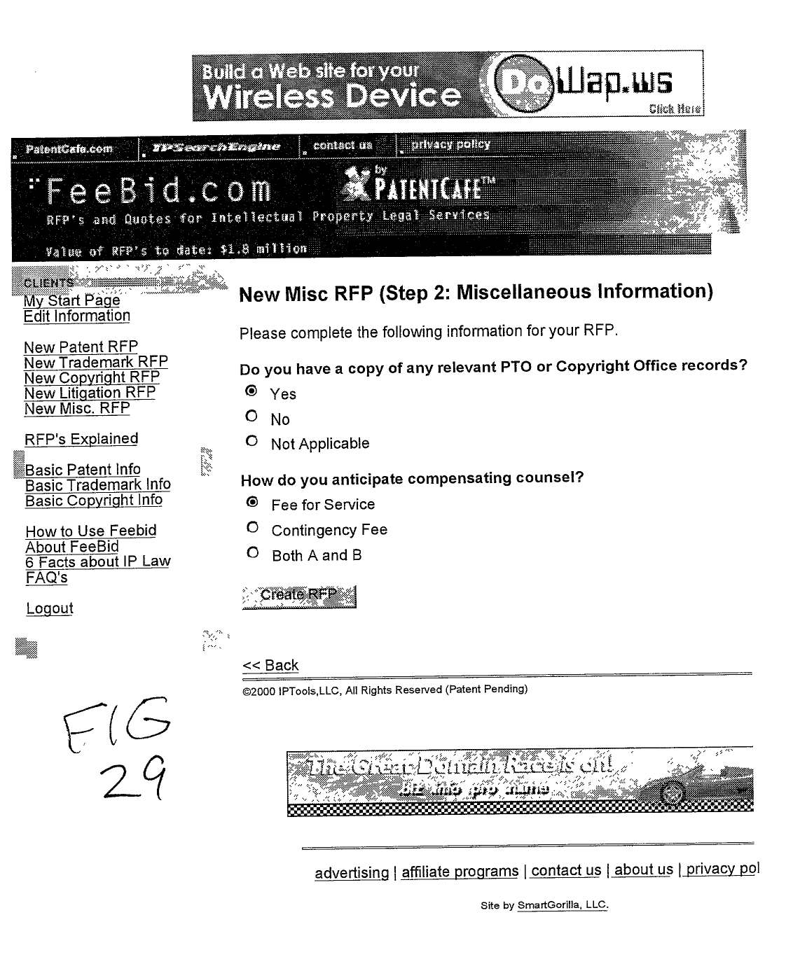

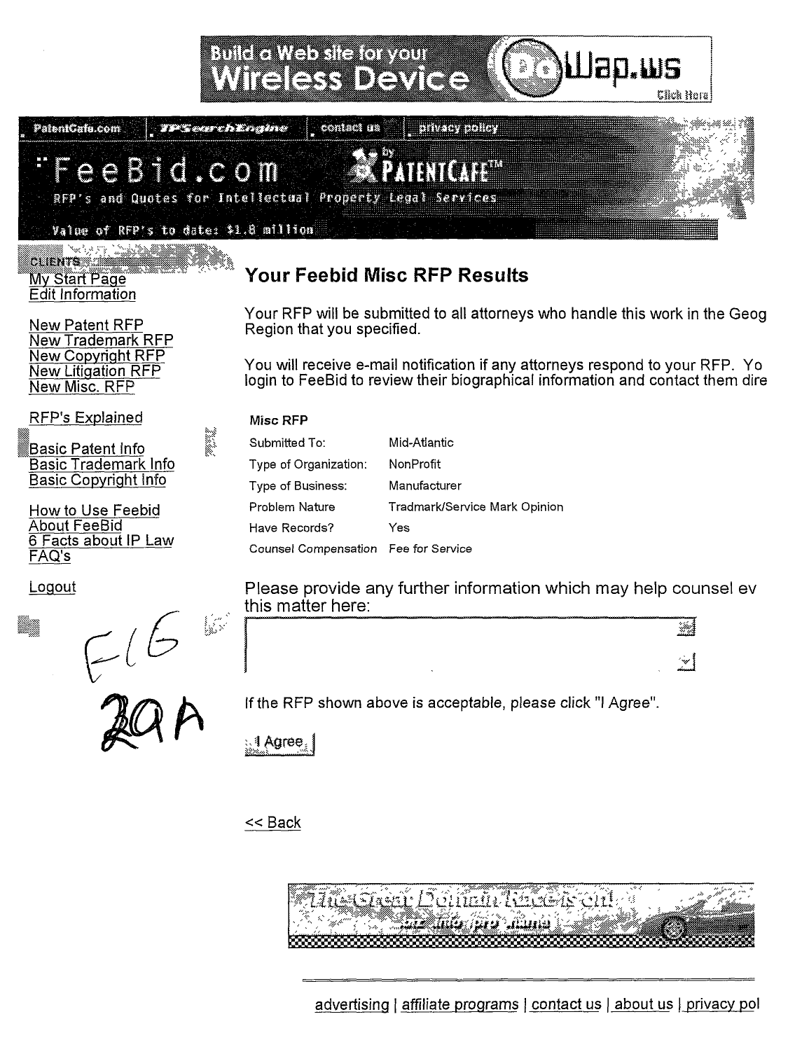

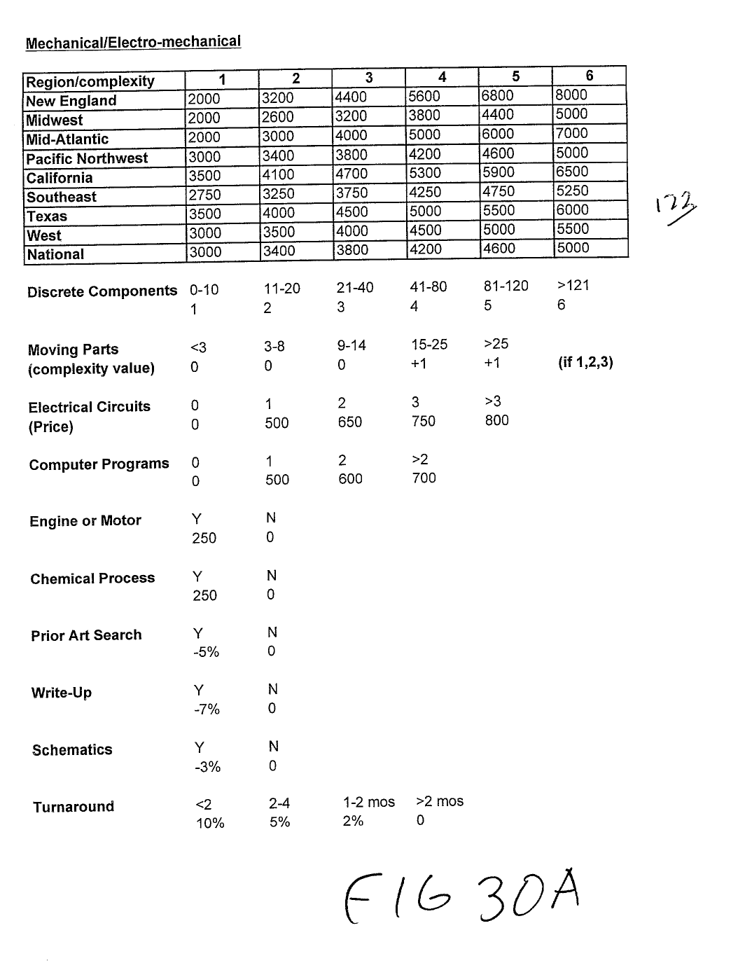

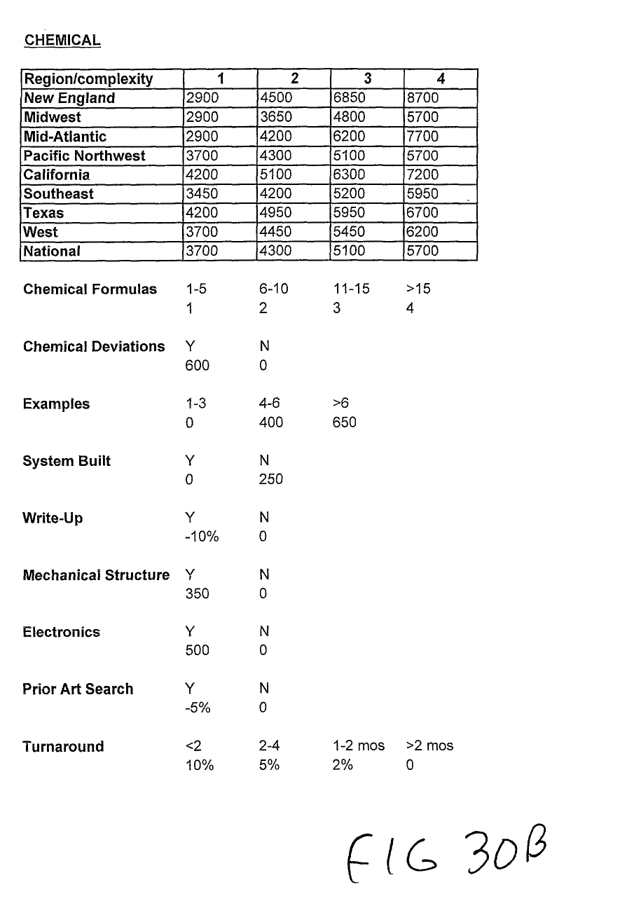

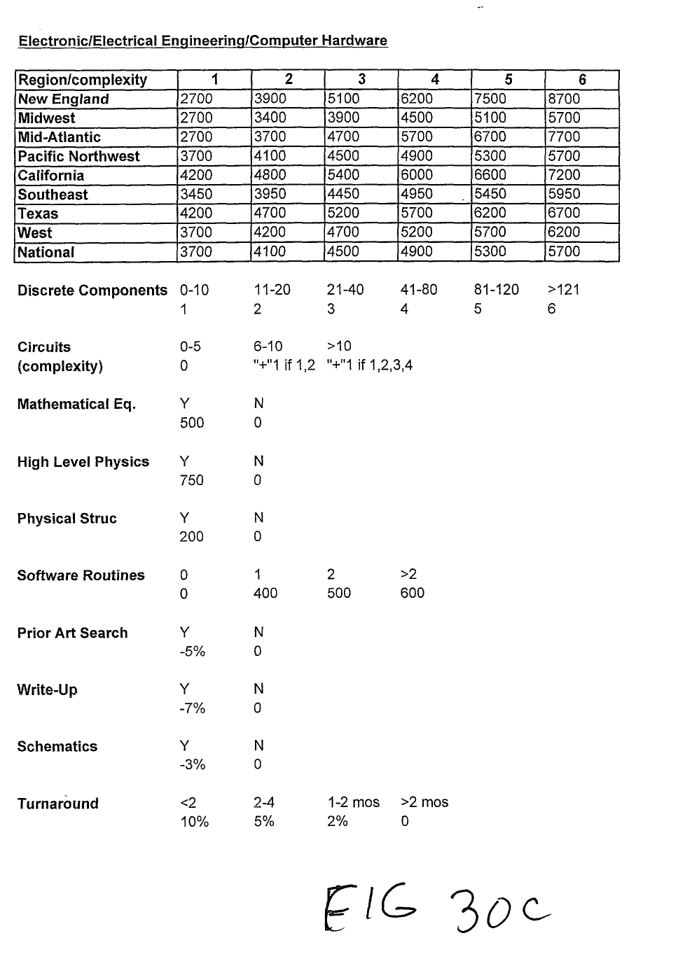

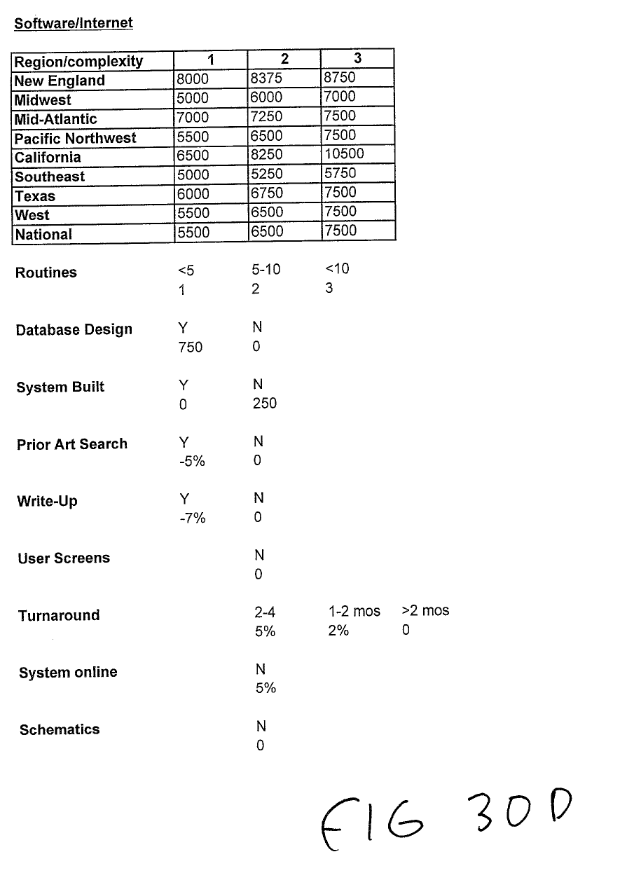

The functioning and operation of the fee formulators for patent is more particularly described with reference to FIGS. 30A-30E. As shown, the fee formulators relate back to a series of tables which are maintained in the database 14. The tables are based upon a series of feegrids 172, maintained in the database 14 based upon empirical evidence of regional and national fees for intellectual property services. One such source of fee information is the published economic survey of the American Intellectual Property Law Association. Other information includes data provided by attorneys.

The data is then categorized based upon geographic location. As shown in FIG. 34, an exemplary embodiment illustrates the 9 geographic regions which are set up in the system. These are New England, Midwest, West, Mid-Atlantic, Southeast, Pacific Northwest, Texas, California and National (which cover all other parts of the world).

In addition to the fee grid, there are additional relational tables which relate to the number of components, turnaround, whether the invention includes a motor or a chemical process. These questions are generic to all of the patent related RFP's The answers to each of these questions adds a dollar value or percentage to the cost of the application.

In an exemplary embodiment, with the exception of the genetic (new form of life) screen, all of the patent types are divided into levels of complexity ranging from 1-6 for mechanical, electro-mechanical, electronic, to 1-4 for chemicals and materials, to 1-3 for software/lnternet/method of business and pharmaceuticals. In the case of mechanical inventions, the complexity level is determined based upon such practices as the number of components and moving parts. The complexity of software/internet patents are determined by the number of routines or flow diagrams. For example, if the client has indicated a mechanical or electro-mechanical invention, he then goes to a series of questions appearing in the mechanical/electro-mechanical page. The first question in this category is the number of discrete components in the invention. How the client answers this determines whether the invention is categorized between 1 and 6. Because the system has recorded the client's state, the system has also recorded region in which the client lives.

Additional queries impact the cost of the application. For example, in mechanical patents, if a class 1, 2 or 3 invention has more than a predetermined number of moving parts, it's classification increases by 1. Using the fee grids, an initial fee is thus established for the project.

As noted additional queries add actual monetary values to the price of the application and then either increase or decrease, by a percentage, the price of the fee. In addition, there is also a percentage factor based upon the time sensitivity of the project as shown. For example, if the client desires to have the application prepared within two weeks, a penalty percentage is added. In the Electronics RFP engine, monetary values are added if the invention includes high level physics or mathematics.

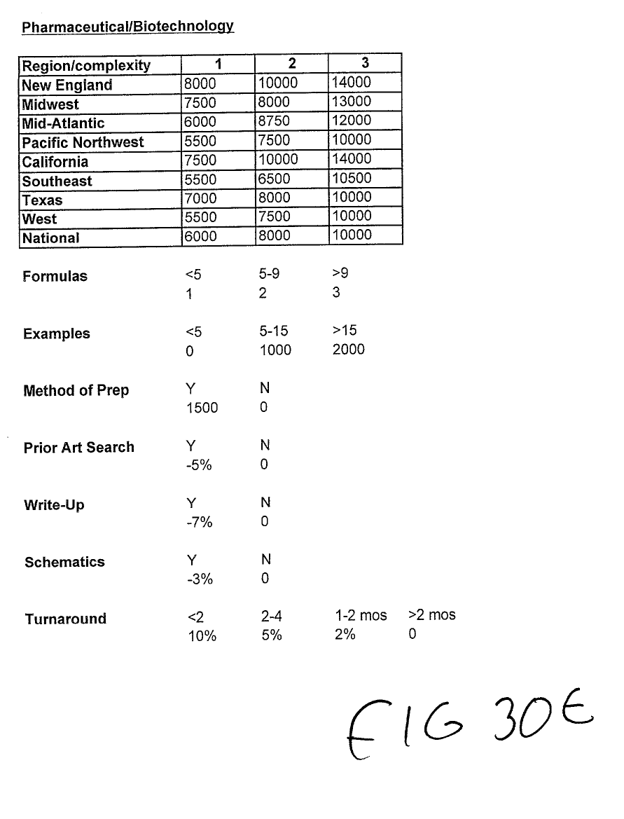

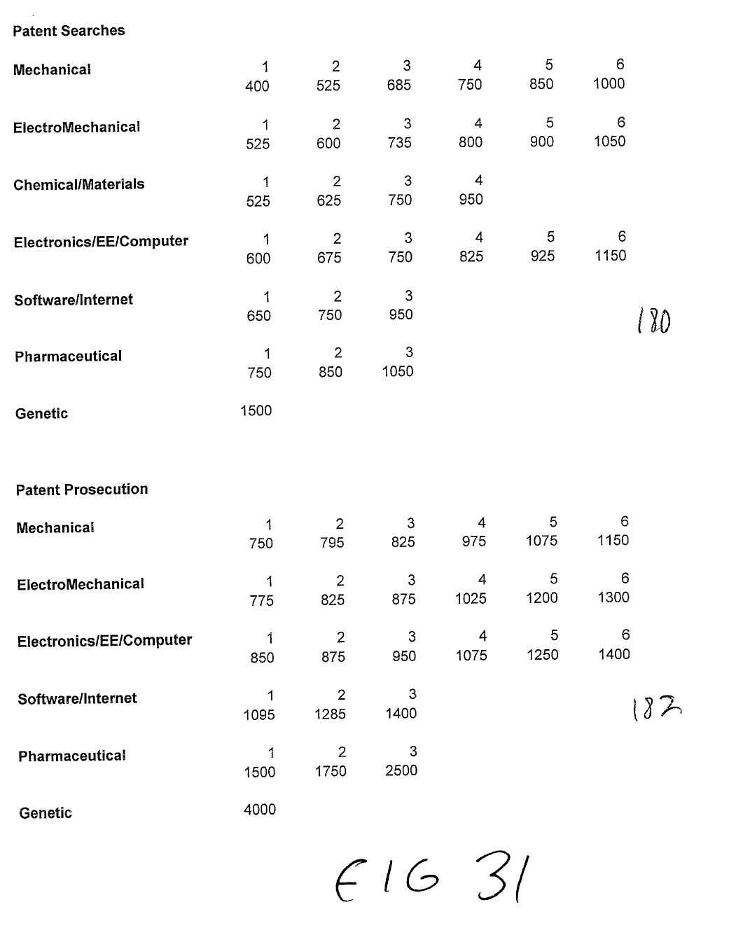

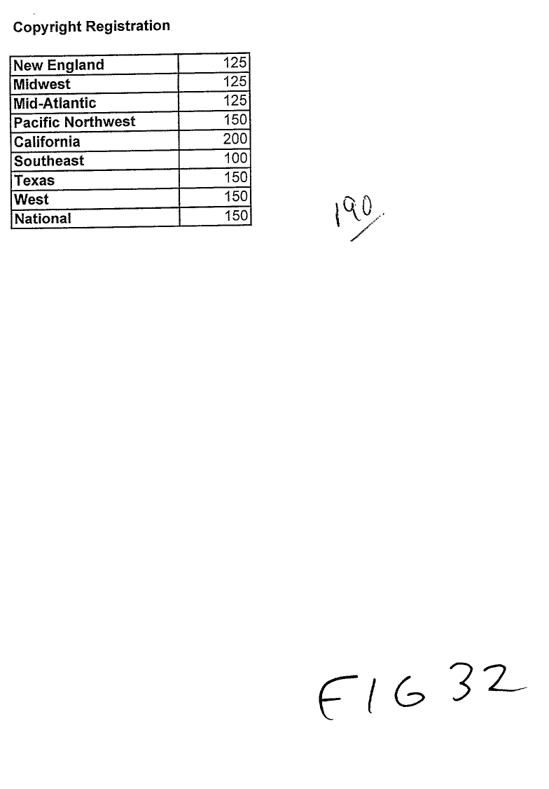

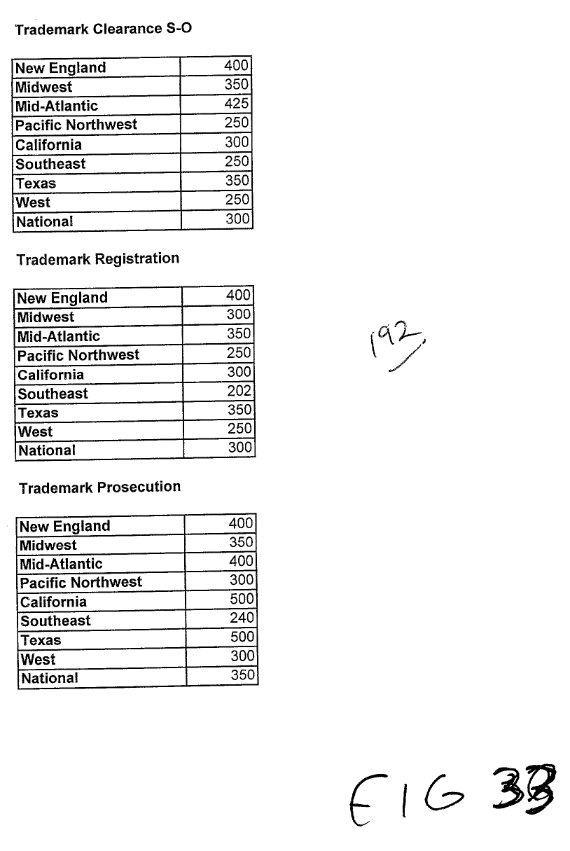

A shown in FIG. 31, the system includes ifee grids for patent searches 180 and for the prosecution 182 of the application through the Patent & Trademark Office. With respect to the patent RFP, it is noted that the difference between mechanical and electro-mechanical is fundamentally determined by the response to the question whether or not a mechanical or electro-mechanical invention has electrical or electronic circuits. If it does not, it is a pure mechanical invention;, if it does, it is an electro-mechanical invention. FIGS. 32 and 33 illustrate the respective tables for copyright registration 190 and trademark registration, proseuciotn and clearance fees 192 by region. Referring to, for example FIGS. 21 and 24, after the client completes the fee request, he is taken to a page which lays out a calculated fee and RFP based the information input into the system. The client can then accept the RFP.

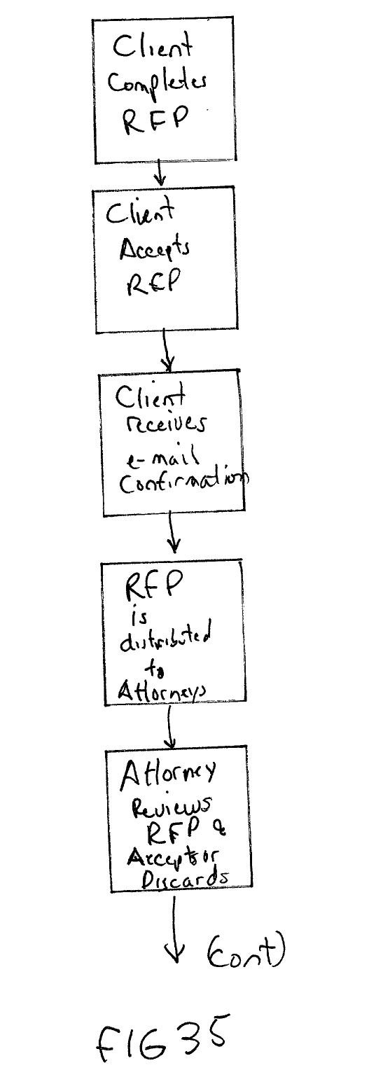

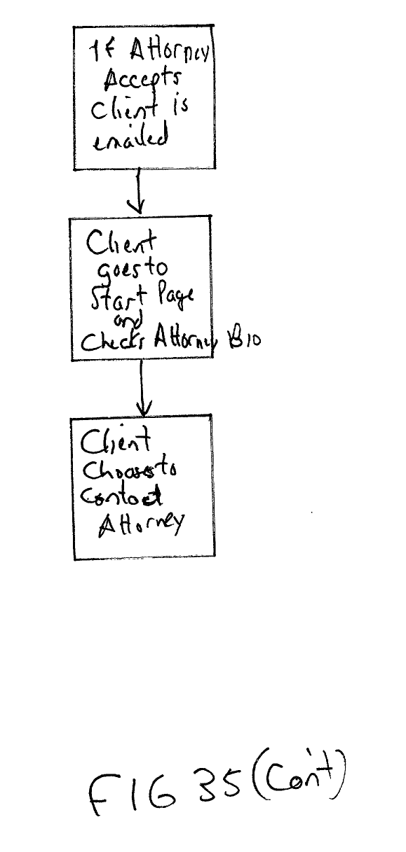

The operation of the present invention is now disclosed with respect to FIG. 35. Initially the client and attorneys register for the service. The client completes the RFP. After the request for proposal is agreed to by the client and entered into the system, the client receives a confirming e-mail that confirms that the RFP has been docketed and emails have been sent out to the requested attorneys. The request for proposal may be stored and saved for a predetermined period such as 30 days.

The attorney who responds, accesses the central website. He then places in his user name and password. He can then access a bid page which will appear on his Start Page. The attorney can accept, reject or delete the RFP. If the attorney accepts the RFP, it is noted in his Start Page. The client is emailed again and the hyperlink to the attorney bio is placed in the client's Start Page.

The client then goes to the site and enters his user name. The client is then taken to his Start Page that sets forth his pending RFPs and where he can obtain the name of the attorney who has responded to the request for proposal. The client can hyperlink to a place in the site which includes the attorney biographical information. The client then has the sole discretion as to whether to contact the attorney or agent.

The present system incorporates an administrative back end which controls the system and which can be used to alter the fee grids and make other administrative changes to the system. One of the features of the present invention is that it can be used incorporated into a weighted average so that fee proposal which has been accepted can be factored into the grids and alter the fee system.

The administrative server provides standard administrative features such as traffic monitoring, providing a log of those who access the site, the identity of attorneys and clients who register with the site, and database parameters such as the geographic location of clients and attorneys and the level of activity broken down by category. Because of the storage of the users in the database, sophisticated fee information can be provided.

In still a further embodiment of the present invention, the present invention is specifically directed to a system in which groups of RFPs can be put together to provide group billing and discounts by which legal services can be compiled and contracted out in a group. In such a situation, the system will be set up so that various RFPs will be grouped together The specific RFPs will be segregated according to specialty or geographic location. A group of RFPs can then be put together and bid on as a unit so as to provide additional discounts to the user. For example, if the client agrees to post an RFP with three or four additional patents, the client could receive a 15% discount on top of the fee generated by the system. For more than three proposals, the discount could be increased to 25%. These discount percentages are merely exemplary.

In still a further embodiment of the present invention, the invention provides for the ability for individual and user customers to identify specific groups of attorneys to whom they wish to receive RFPs. This embodiment permits a potential client to identify a predetermined list of attorneys and choose his or her counsel, thereby limiting the dissemination of the RFP.

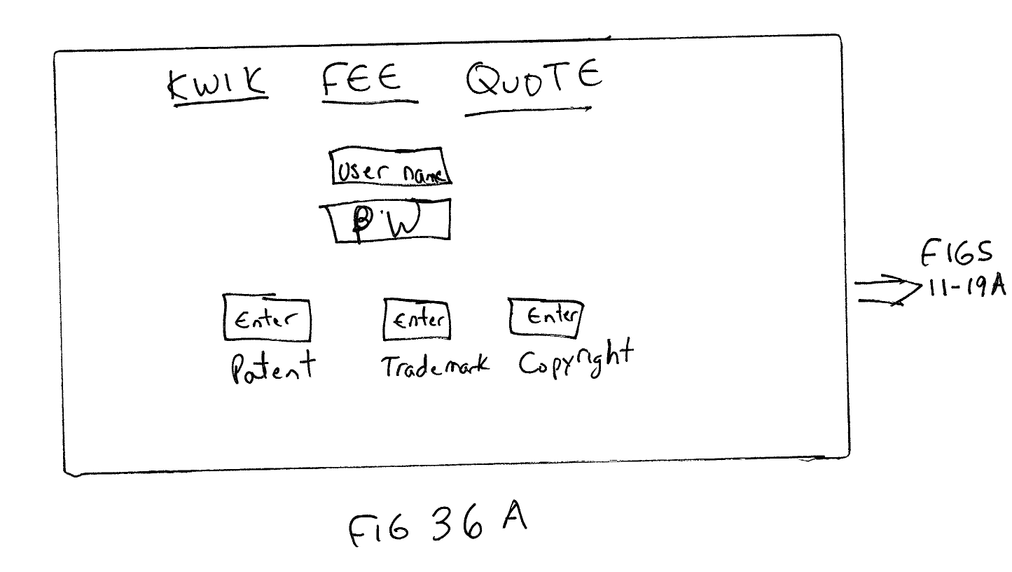

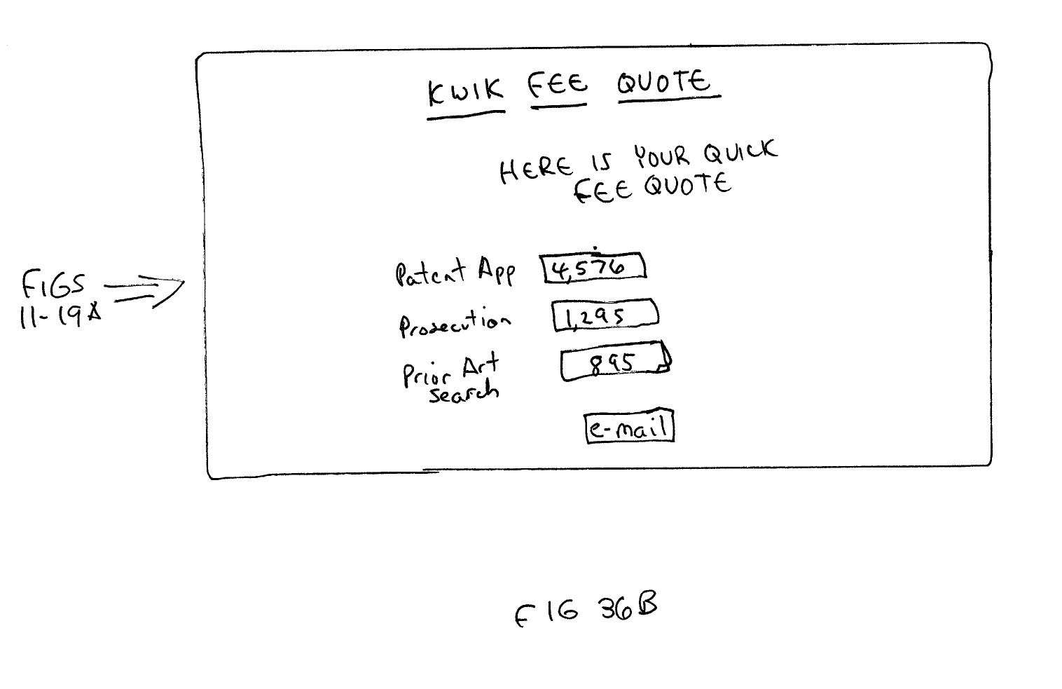

In still yet a further embodiment of FIGS. 36A and 36B, the present invention may comprise a streamlined system in which a client may merely enter a user name and password and then request a fee estimate without entering a formal RFP. Such a streamlined system will comprise a simple sign in page. The client will designate the type of fee quote required and then be sent to screens similar to those shown in FIGS. 11 to 29A. The client will merely receive a fee quote which can then be used by the client to independently find his or her own attorney without submitting an RFP.

In still a further embodiment, the present invention comprises a tool by which RFPs fee quotes can be input into the system. For example, a menu driven tool will enable an entity to define a series of queries and place dollar or percentage values so as to generate an RFP based fee quote.

While the present invention has been described in the context of a system for generating patent, trademark and copyright fees, it is to be appreciated that the teachings of the present invention are applicable to a wide variety of fees such as foreign prosecution and the like. A fee generator can be created for patent prosecution. A base number can be altered based upon such variable as the number of rejected claims ands whether the rejections are based upon Section 102 or 103 of the Patent Statute. A multiplier or percentage can be added based upon the number of prior art references which form the basis of the rejection.

The present invention is described with reference to the above-discussed preferred embodiments. It is to be recognized that other embodiments fulfill the spirit and scope of the present invention and that the true nature and scope of the present invention is to be determined with reference to the claims attached hereto.

1. An apparatus for matching an intellectual property attorney and prospective client comprising:
a control unit for establish a request generated by a prospective client, relating to a desire for intellectual property legal services;
means for assisting a client in formulating a request for proposal including a customized fee quote to be distributed to attorneys throughout the system;
means for distributing the request for proposal with customized fee quote to said attorneys; and
means for receiving bids from attorneys who receive the request for proposal including customized fee quote.

2. An intellectual property attorney matching apparatus for managing communications between an intellectual property attorney and a prospective client seeking the services of said attorney, comprising:
a control unit for receiving a request from a prospective client relating to desired intellectual property law services;
means for assisting the prospective client in formulating a request for proposal including a customized fee quote based upon a plurality of client inputs to be formatted and distributed throughout a network;
means for distributing the request for proposal throughout a network to a plurality of intellectual property attorneys;
means for intellectual property attorneys to respond to the request for proposal with a bid; and
means for the prospective client to request additional information from the attorney.

3. A method for electronically managing communications between an intellectual property attorney having particular qualifications and an end user seeking a solution to an end user request, comprising the steps of:
providing a control unit having a database for storing therein a plurality of intellectual property practitioners, each practitioner's e-mail address corresponding to the intellectual property practitioner;
providing an interface to an end user to the system to formulate a request for proposal in conjunction with a request for legal services including a fee request;
sending out the request for proposal to a plurality of intellectual property practitioners who may respond with responses.

4. An apparatus for generating a fee quote for intellectual property law services comprising:
a control unit for establishing a request generated by a prospective client, relating to a desire for a fee quote related to intellectual property legal services;
means for assisting a client in inputting information related the nature of the desired sercvies; and
means for generating a fee quote based upon the information provided by the client.
